(19) United States
(12) Patent Application Publication
(10) Pub. No.: US 2024/0171780 A1
(43) Pub. Date: May 23, 2024

(54) GENERAL REGION-BASED HASH

(71) Applicant: Nokia Technologies Oy, Espoo (FI)

(72) Inventors: Limin WANG, San Diego, CA (US); Seungwook HONG, San Diego, CA (US); Krit PANUSOPONE, San Diego, CA (US); Miska Matias HANNUKSELA, Tampere (FI)

(21) Appl. No.: 18/551,100

(22) PCT Filed: Mar. 9, 2022
(86) PCT No.: PCT/EP2022/055996

§ 371 Date: Sep. 18, 2023

Related U.S. Application Data
(60) Provisional application No. 63/165,910, filed on Mar. 25, 2021.

(51) Int. Cl. H04N 19/70; H04N 19/17; H04N 19/186

(52) U.S. Cl. CPC H04N 19/70; H04N 19/17; H04N 19/186

(57) ABSTRACT

Example embodiments of the invention provide at least methods and apparatus to perform interpreting at an encoder of a communication network a region of at least one reconstructed picture: and based on the interpreting, generating compressed bits for generating the at least one reconstructed picture comprising at least one hash and using at least one specified variable, wherein based on the generating it can be determined whether or not the at least one hash of the at least one reconstructed picture is matched to at least one other hash. Further, to perform interpreting compressed bits for constructing at least one reconstructed picture, wherein at least one region of the at least one reconstructed picture comprises at least one hash and is using at least one specified variable, wherein the interpreting comprises generating at least one other hash: and comparing the at least one hash of the at least one reconstructed picture to the at least one other hash for determining whether or not at least one hash of the at least one reconstructed picture is matched to the at least one other hash.

### TECHNICAL FIELD

The teachings in accordance with the exemplary embodiments of this invention relate generally to interpreting at an encoder or decoder compressed bits for construction of at least one reconstructed picture comprising a at least one hash and using at least one specified variable and, more specifically, relate to interpreting at an encoder or decoder a region of at least one reconstructed picture using at least one specified variable to determine whether or not at least one hash of the at least one reconstructed picture is matched to at least one other hash.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
CU: Coding Unit
CTU: Coding Tree Unit
GDR: Gradual Decoding Refresh
GRA: Gradual Random Access
HEVC: High Efficiency Video Coding
JVET: Joint Video Experts Team
PIR: Progressive Intra Refresh
SEI: Supplemental Enhancement Information
VVC Versatile Video Coding

The High Efficiency Video Coding standard (which may be abbreviated HEVC or H.265/HEVC) was developed by the Joint Collaborative Team-Video Coding (JCT-VC) of ITU-T VCEG and ISO/IEC MPEG. The standard is published by both parent standardization organizations, and it is referred to as ITU-T Recommendation H.265 and ISO/IEC International Standard 23008-2, also known as MPEG-H Part 2 High Efficiency Video Coding (HEVC).

The Versatile Video Coding standard (VVC, H.266, or H.266/VVC) was developed by the Joint Video Experts Team (JVET), which is a collaboration between the ISO/IEC MPEG and ITU-T VCEG. The standard is published by both parent standardization organizations, and it is referred to as ITU-T Recommendation H.266 and ISO/IEC International Standard 23090-3, also known as MPEG-I Part 3.

In Versatile Video Coding (VVC) at the time of this application a decoded picture hash can be used to verify if the reconstructed pictures at encoder and decoder are matched or not. The decoded picture hash is calculated based upon the entire picture.

Specifically, for each picture:

encoder generates a hash for the reconstructed picture at encoder, and signals the hash via an SEI message (which is called the decoded picture hash SEI message in VSEI [2]),
decoder also generates a hash for the reconstructed picture at decoder, and compares the generated hash with the received hash from SEI message, and
if the hashes at encoder and decoder are matched, the reconstructed pictures at encoder and decoder are matched, otherwise not matched.

However, the picture-based hash may not be suitable for some applications, such as GDR, subpicture, 360° videos, etc, where only local region(s) of a picture are of interest. For example, for GDR applications, to meet the exact match requirement, only the clean (or refreshed) areas of GDR pictures and recovering pictures need to be the same at encoder and decoder. For the case of subpicture, maybe only some of subpictures need to be checked. For 360° videos, maybe, only one local region (or viewpoint) is of interest

Example embodiments of the invention work to address at least these issues.

### SUMMARY

This section contains examples of possible implementations and is not meant to be limiting.

In an example aspect of the invention, there is a method comprising: interpreting at an encoder of a communication network a region of at least one reconstructed picture: and based on the interpreting, generating compressed bits for constructing the at least one reconstructed picture comprising at least one hash and using at least one specified variable, wherein based on the generating it can be determined whether or not the at least one hash of the at least one reconstructed picture is matched to at least one other hash.

A non-transitory computer-readable medium storing program code, the program code executed by at least one processor to perform at least the method as described in the paragraphs above.

In an example aspect of the invention, there is an apparatus, comprising at least one processor, and at least one non-transitory memory including computer program code, wherein the at least one non-transitory memory including computer program code is configured with the at least one processor to cause the apparatus to: interpretat an encoder of a communication network a region of at least one reconstructed picture: and based on the interpreting, generate compressed bits for constructing the at least one reconstructed picture comprising at least one hash and using at least one specified variable, wherein based on the generating it can be determined whether or not the at least one hash of the at least one reconstructed picture is matched to at least one other hash.

A further example embodiment is a method and apparatus comprising the method and apparatus of the previous paragraphs, wherein there is sending the compressed bits for constructing the at least one reconstructed picture towards a decoder of the communication network, wherein the determining is using a region-based hash supplemental enhancement information message encoded in the at least one reconstructed picture, wherein the determining is using a region-nested hash supplemental enhancement information message encoded in the at least one reconstructed picture, wherein one or more regions are specified in the region-nested hash supplemental enhancement information message, and semantics of the region-nested hash supplemental enhancement information message are interpreted as applying to each of the specified one or more regions, wherein the region-based hash supplemental enhancement information message comprises region-specific hash information, wherein the region-specific hash information comprises a region-based supplemental enhancement information message, wherein the region-based hash supplemental enhancement information message comprises definitions of at least one specified variable of the dimension array, wherein the definitions comprise: a region with its top-left luma sample relative to the top-left luma sample of the current picture is denoted by (RegionX0, RegionY0), and width and height denoted by Region Width and RegionHeight, wherein when RegionX0 or RegionY0 is not set, RegionX0 or RegionY0 is inferred to be equal to 0, or wherein when RegionWidth or RegionHeight is not set, RegionWidth or RegionHeight is inferred to be equal to PicWidthInLumaSamples or PicHeightInLumaSamples, respectively, wherein the region-based hash supplemental enhancement information message comprises a decoded region hash, wherein the decoded region hash comprises indications of region settings for the at least one reconstructed picture, wherein the region settings comprise indications of a dimension array for determining if the at least one hash of the at least one reconstructed picture is matched or not, wherein the dimension array comprises values identifying the at least one specified variable for the interpreting, wherein the at least one specified variable comprises: RegionX0 is set equal to region_x0, RegionY0 is set equal to region_y0. RegionWidth is set equal to region_width, and RegionHeight is set equal to region_height, wherein: region_x0 is a horizontal offset from a top-left corner of the at least one reconstructed picture, region_y0 is a vertical offset from a top-left corner of the at least one reconstructed picture, region_width is a width of a specific region of the at least one reconstructed picture, and region_height is a height of a specific region of the at least one reconstructed picture, and/or wherein at least one hash of the at least one reconstructed picture provides a hash for each colour component of at least one region of the at least one reconstructed picture.

In another example aspect of the invention, there is an apparatus comprising: means for interpreting at an encoder of a communication network a region of at least one reconstructed picture: and means, based on the interpreting, for generating compressed bits for constructing the at least one reconstructed picture comprising at least one hash and using at least one specified variable, wherein based on the generating it can be determined whether or not the at least one hash of the at least one reconstructed picture is matched to at least one other hash.

In accordance with the example embodiments as described in the paragraph above, at least the means for interpreting, generating, and determining comprises a network interface, and computer program code stored on a computer-readable medium and executed by at least one processor.

In another example aspect of the invention, there is a method comprising: interpreting at a decoder of a communication network compressed bits for constructing at least a region of at least one reconstructed picture, wherein the at least one reconstructed picture comprises at least one hash and is using at least one specified variable, wherein the interpreting comprises generating at least one other hash: and comparing the at least one hash of the at least one reconstructed picture to the at least one other hash for determining whether or not at least one hash of the at least one reconstructed picture is matched to the at least one other hash.

A non-transitory computer-readable medium storing program code, the program code executed by at least one processor to perform at least the method as described in the paragraphs above.

In another In an example aspect of the invention, there is an apparatus, comprising at least one processor, and at least one non-transitory memory including computer program code, wherein the at least one non-transitory memory including computer program code is configured with the at least one processor to cause the apparatus to interpret at a decoder of a communication network compressed bits for constructing at least a region of at least one reconstructed picture, wherein the at least one reconstructed picture comprises at least one hash and is using at least one specified variable, wherein the interpreting comprises generating at least one other hash: and compare the at least one hash of the at least one reconstructed picture to the at least one other hash for determining whether or not at least one hash of the at least one reconstructed picture is matched to the at least one other hash.

A further example embodiment is a method and apparatus comprising the method and apparatus of the previous paragraphs, wherein there is receiving the compressed bits for constructing at least a region of at least one reconstructed picture from an encoder of the communication network the at least one reconstructed picture comprising at least one hash and using at least one specified variable, wherein the determining is using a region-based hash supplemental enhancement information message encoded in the at least one reconstructed picture, wherein the determining is using a region-nested hash supplemental enhancement information message encoded in the at least one reconstructed picture, wherein one or more regions are specified in the region-nested hash supplemental enhancement information message, and semantics of the region-nested hash supplemental enhancement information message are interpreted as applying to each of the specified one or more regions, wherein the region-based hash supplemental enhancement information message comprises region-specific hash information, wherein the region-specific hash information comprises a region-based supplemental enhancement information message, wherein the region-based hash supplemental enhancement information message comprises definitions of at least one specified variable of the dimension array, wherein the definitions comprise: a region with its top-left luma sample relative to the top-left luma sample of the current picture is denoted by (RegionX0, RegionY0), and width and height denoted by RegionWidth and RegionHeight, wherein when RegionX0 or RegionY0 is not set, RegionX0 or RegionY0 is inferred to be equal to 0, or wherein when RegionWidth or RegionHeight is not set, RegionWidth or RegionHeight is inferred to be equal to PicWidthInLumaSamples or PicHeightInLumaSamples, respectively, wherein the region-based hash supplemental enhancement information message comprises a decoded region hash, wherein the decoded region hash comprises indications of region settings for the at least one reconstructed picture, wherein the region settings comprise indications of a dimension array for determining if the at least one hash of the at least one reconstructed picture is matched or not, wherein the dimension array comprises values identifying the at least one specified variable for the interpreting, wherein the at least one specified variable comprises: RegionX0 is set equal to region_x0, RegionY0 is set equal to region_y0, Region Width is set equal to region_width, and RegionHeight is set equal to region_height, wherein: region_x0 is a horizontal offset from a top-left corner of the at least one reconstructed picture, region_y0 is a vertical offset from a top-left corner of the at least one reconstructed picture, region_width is a width of a specific region of the at least one reconstructed picture, and region_height is a height of a specific region of the at least one reconstructed picture, and/or wherein at least one hash of the at least one reconstructed picture provides a hash for each colour component of at least one region of the at least one reconstructed picture.

In another example aspect of the invention, there is an apparatus comprising: means for interpreting at a decoder of a communication network compressed bits for constructing at least a region of at least one reconstructed picture, wherein the at least one reconstructed picture comprises at least one hash and is using at least one specified variable, wherein the interpreting comprises generating at least one other hash: and means for comparing the at least one hash of the at least one reconstructed picture to the at least one other hash for determining whether or not at least one hash of the at least one reconstructed picture is matched to the at least one other hash.

In accordance with the example embodiments as described in the paragraph above, at least the means for interpreting, generating, and determining comprises a network interface, and computer program code stored on a computer-readable medium and executed by at least one processor.

A communication system comprising the encoder side apparatus and decoder side apparatus performing operations as described above.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1A and FIG. 1B shows changes to a General SEI payload syntax (H.266) of a General SEI payload in accordance with an example embodiment of the invention:

FIG. 1C shows a Decoded region hash SEI message (H.274);

FIG. 2 illustrates a vertical GRA approach:

FIG. 3A and FIG. 3B shows changes to a General SEI payload syntax (H.266) of a General SEI payload in accordance with another example embodiment of the invention:

FIG. 4 shows Decoded regional nesting SEI message (H.274) in accordance with an example embodiment of the invention:

FIG. 5 shows a high level block diagram of various devices used in carrying out various aspects of the invention; and

FIG. 6A and FIG. 6B each show a method in accordance with example embodiments of the invention which may be performed by an apparatus.

### DETAILED DESCRIPTION

In example embodiments of the invention there is provided at least a method performed by an apparatus for interpreting at an encoder or decoder compressed bits for constructing a region of at least one reconstructed picture to determine whether or not at least one hash of the at least one reconstructed picture is matched to at least one other hash.

Some definitions, bitstream and coding structures, and concepts of HEVC and VVC are described in this section as an example of a video encoder, decoder, encoding method, decoding method, and a bitstream structure, wherein the embodiments may be implemented. Some of the key definitions, bitstream and coding structures, and concepts of the video coding standards are common—hence, they are described below jointly. The aspects of various embodiments are not limited to HEVC or VVC, or their extensions, but rather the description is given for one possible basis on top of which the present embodiments may be partly or fully realized.

Gradual Decoding Refresh (GDR) (Gradual Random Access (GRA) or Progressive Intra Refresh (PIR)) approaches alleviate the delay issue with intra coded pictures. Instead of coding an intra picture at a random access point, GDR progressively refreshes pictures by spreading intra coded areas over several pictures.

A video coding system may comprise an encoder that transforms an input video into a compressed representation suited for storage/transmission and/or a decoder that can uncompress the compressed video representation back into a viewable form. An example video coding system 10 can comprise an encoder 12, a decoder 14 and a display 16. The encoder 12 may comprise, or be connected to, circuitry such as at least one processor 18 and at least one memory 20 comprising software or computer code 22 for performing function or operations. The decoder 14 may comprise, or be connected to, circuitry such as at least one processor 24 and at least one memory 26 comprising software or computer code 28 for performing function or operations. The at least one memory 20 and 26 comprising non-transitory memories. A communications link 30 may be used to couple the encoder to the decoder. A communications link 32 may be used to couple the decoder to the display 16.

Many coding standards/approaches, such as the Joint Video Experts Team's (JVET) Versatile Video Coding (VVC) standard (ITU-T Recommendation H.266, 08/2020), the entire contents of which is hereby incorporated herein by reference, may provide for inter-prediction of coding units (CUs) based on neighboring CUs. Based on the current standard, a particular intra coding approach from among 67 or more available coding approaches can be selected for intra prediction of a pixel, coding tree unit (CTU), neighboring CUs, and/or the like.

In some embodiments, a picture can be divided into one or more tile rows and one or more tile columns. A tile is a sequence of CTUs that covers a rectangular region of a picture. In some embodiments, a slice either contains a number of tiles of a picture or a number of CTU rows of a tile. In some embodiments, two modes of slices are supported, namely the raster-scan slice mode and the rectangular slice mode. In the raster-scan slice mode, a slice contains a sequence of tiles in a tile raster scan of a picture. In the rectangular slice mode, a slice contains either a number of tiles of a picture that collectively form a rectangular region of the picture or a number of CTU rows of a tile.

In some embodiments, the samples can be processed in units of coding tree blocks (CTBs). In some embodiments, the array size for each luma CTB in both width and height is CtbSizeY in units of samples. In some embodiments, the width and height of the array for each chroma CTB are CtbWidthC and CtbHeightC, respectively, in units of samples

In some embodiments, each CTB is assigned a partition signaling to identify the block sizes for intra or inter prediction and for transform coding. In some embodiments, the partitioning is a recursive quadtree partitioning. In some embodiments, the root of the quadtree is associated with the CTB. In some embodiments, the quadtree is split until a leaf is reached, which is referred to as the quadtree leaf. In some embodiments, when the component width is not an integer number of the CTB size, the CTBs at the right component boundary are incomplete. In some embodiments, when the component height is not an integer multiple of the CTB size, the CTBs at the bottom component boundary are incomplete.

In some embodiments, the coding block is the root node of two trees, the prediction tree and the transform tree. In some embodiments, the prediction tree specifies the position and size of prediction blocks. In some embodiments, the transform tree specifies the position and size of transform blocks. In some embodiments, the splitting information for luma and chroma is identical for the prediction tree and may or may not be identical for the transform tree.

In some embodiments, spatial or component-wise partitioning can be carried out by the division of each picture into components, the division of each component into CTBs, the division of each picture into tile columns, the division of each picture into tile rows, the division of each tile column into tiles, the division of each tile row into tiles, the division of each tile into bricks, the division of each tile into CTUs, the division of each brick into CTUs, the division of each picture into slices, the division of each slice into bricks, the division of each slice into CTUs, the division of each CTU into CTBs, the division of each CTB into coding blocks, except that the CTBs are incomplete at the right component boundary when the component width is not an integer multiple of the CTB size and the CTBs are incomplete at the bottom component boundary when the component height is not an integer multiple of the CTB size, the division of each CTU into coding units, except that the CTUs are incomplete at the right picture boundary when the picture width in luma samples is not an integer multiple of the luma CTB size and the CTUs are incomplete at the bottom picture boundary when the picture height in luma samples is not an integer multiple of the luma CTB size, the division of each coding unit into transform units, the division of each coding unit into coding blocks, the division of each coding block into transform blocks. the division of each transform unit into transform blocks, and/or the like.

According to at least some of the currently used video coding approaches, e.g., advanced video coding (AVC), high-efficiency video coding (HEVC), versatile video coding (VVC), etc., a coded video sequence consists of intra coded pictures (e.g., I picture) and inter coded pictures (e.g., P and B pictures). According to many, if not all current approaches, intra coded pictures typically require many more bits than inter coded pictures. As such, a transmission time of intra coded pictures increases the encoder to decoder delay as compared to similar inter coded pictures. For low and ultra-low delay applications, it is often desirable that all the coded pictures have similar number of bits so that the encoder to decoder delay can be reduced to around one picture interval. Hence, intra coded picture often cannot be used for low and ultra-low delay applications. However, on the other hand, an intra coded picture is indeed needed at random access points.

Gradual Decoding Refresh (GDR) often refers to the ability to start decoding at a non-IDR (Instantaneous Decoder Refresh) picture and to recover decoded pictures that are correct in content after decoding a certain amount of pictures. Said otherwise, GDR can be used to achieve random access from non-intra pictures. Approaches for GDR, such as Gradual Random Access (GRA) or Progressive Intra Refresh (PIR), can alleviate the delay issue with intra coded pictures. Instead of coding an intra picture at a random access point, GDR progressively refreshes pictures by spreading intra coded areas over several pictures.

All Video Coding Layer (VCL) Network Abstraction Layer (NAL) units of a GDR picture may have a particular NAL unit type value that indicates a GDR NAL unit. It is possible to start decoding from a GDR picture. A recovery point may be indicated within a GDR picture, e.g. as a picture order count (POC) difference compared to the POC of the GDR picture. When the decoding started from the GDR picture, the decoded recovery point picture and all subsequent decoded pictures in output order are correct in content. Pictures between the GDR picture and the recovery point picture, in decoding order, may be referred to as recovering pictures. Recovering pictures may be partially correct in content, when the decoding started from the GDR picture.

A GDR picture often consists of one or more clean areas and one or more dirty areas, where clean areas may contain a forced intra area next to a dirty area for progressive intra refresh (PIR). In some embodiments, a picture, such as a GDR picture, can be divided vertically, horizontally, diagonally, or otherwise into a “clean” tile group area, a “refresh” tile group area, and a “dirty” or “not-yet-refreshed” tile group area. As such, as used herein, “clean area” refers to an area of CUs or CTUs within a picture that have already been refreshed, e.g., via intra prediction refresh. As used herein, “dirty area” refers to an area of CUs or CTUs within a picture that have not yet been refreshed, e.g., via intra prediction refresh. As used herein, “refresh area” refers to an area of CUs or CTUs within a picture that are being refreshed, e.g., by intra prediction refresh using only CUs or CTUs from within a “clean area” of the picture which has already been refreshed.

For example, according to a VVC approach according to a particular embodiment, a picture header can be used, the picture header comprising virtual boundary syntax. A virtual boundary can include or be one or more vertical or horizontal lines. In some embodiments, when virtual boundary syntax is included in a picture header, a picture can have its own virtual boundaries. For example, a GDR picture can define the boundary between a clean area and dirty area as a virtual boundary.

FIG. 2 illustrates a vertical GRA approach. FIG. 2 illustrates the basic concept of (vertical) GDR, where a GDR period starts with picture of POC (n) and ends with picture of POC(n+N−1), including N pictures in total. The first picture of POC(n) within the GDR period is called GDR picture. Forced intra coded areas (green) gradually spread over the N pictures of the GDR period from the left to the right. The picture of POC(n+N) at the recovery point is called the recovery point picture. Thus, a GDR period starts with a GDR picture of POC(n) and ends with picture of POC(n+N−1), and a picture within the GDR period consists of a clean area and a dirty area separated by a virtual boundary.

In vertical GRA, the intra coded area (darker) moves and the clean area (lighter) expands from left to right over pictures. In both the vertical GRA approach and horizontal GRA approach, the reference pixels for CUs in the intra coded area may be in the dirty area, and hence, some restrictions on intra prediction may need to be imposed.

As shown in FIG. 2, intra coded areas (darker) move from left to right over N pictures and the clean area (lighter) expends gradually from a random access point (POC(n)) within a picture order count (POC) to a recovery point POC(N+n) of the POC. A virtual boundary (dashed line) separates the clean area and the dirty area of a GDR picture. A virtual boundary (dashed line) is also illustrated in the

GDR picture of FIG. 2.

Typically, a current picture within a GDR period consists of a (refreshed) clean area and a (non-refreshed) dirty area, where the clean area may contain a forced intra area next to the dirty area for progressive intra refresh (PIR), as shown in picture of POC(n+1) of In VVC, the boundary between clean area and dirty area can be signaled by virtual boundary syntax in Picture Header.

One of requirements for VVC GDR is so-called “exact match” at the recovery point. For exact match, the reconstructed recovery point pictures at encoder and decoder need to be the same (or be matched).

To achieve exact match, CUs in clean areas cannot use any coding information from dirty areas, which is because the coding information in dirty area may not be decoded correctly at decoder. For example, an intra CU in clean area can only use the reference samples in clean area of current picture, and an inter CU in clean area cannot refer to the clean areas of reference pictures.

VVC supports subpictures (a.k.a. sub-pictures). A subpicture may be defined as a rectangular region of one or more slices within a picture, wherein the one or more slices are complete. Consequently, a subpicture consists of one or more slices that collectively cover a rectangular region of a picture. The slices of a subpicture may be required to be rectangular slices. Consequently, each subpicture boundary is also always a slice boundary, and each vertical subpicture boundary is always also a vertical tile boundary.

One or both of the following conditions shall be fulfilled for each subpicture and tile: condition 1—all CTUs in a subpicture belong to the same tile: condition 2—all CTUs in a tile belong to the same subpicture.

Partitioning of a picture to subpictures (a.k.a. subpicture layout) may be indicated in and/or decoded from an SPS. In VVC, the SPS syntax indicates the partitioning of a picture to subpictures by providing for each subpicture syntax elements indicative of: the x and y coordinates of the top-left corner of the subpicture, the width of the subpicture, and the height of the subpicture, in CTU units.

In addition to the subpicture layout, one or more of the following properties may be indicated (e.g. by an encoder) or decoded (e.g. by a decoder) or inferred (e.g. by an encoder and/or a decoder) for the subpictures collectively or per each subpicture individually: i) whether or not a subpicture is treated as a picture in the decoding process: in some cases, this property excludes in-loop filtering operations, which may be separately indicated/decoded/inferred: and ii) whether or not in-loop filtering operations are performed across the subpicture boundaries.

The VVC subpicture feature enables extraction of subpicture(s) from one or more video bitstreams and/or merging of subpictures into a destination bitstream without modifications of VCL NAL units (i.e. slices). Such extraction and/or merging may be used for example in viewport-dependent streaming of omnidirectional video (covering up to 360°) as described in the following paragraphs.

Conventional transmission of the whole 360° content, at the highest resolution and quality, not only consumes an unnecessary high network bandwidth, but also requires high computational complexity to decode the whole content. However, in practice, at any time instance, only a portion of a 360° video, limited to the field of view (FOV) of the head-mounted display (HMDs) in use, is watched by the viewer. Hence, different viewport-dependent or viewport-adaptive streaming (VAS) schemes have been developed to reduce the bandwidth consumption, in which only the current viewport of the client is transmitted in high-quality (HQ). Furthermore, due to latency of the codec and transmission system, the rest of the content (i.e. non-viewport part) may also be sent in low-quality (LQ) to provide a fallback in the case of quick head movement.

Subpictures can be used for VAS in a manner that the client selects at which quality and resolution each subpicture is received. The received subpictures are merged into a video bitstream, which is decoded by a single decoder instance.

Encoding aspects for GDR are discussed in the subsequent paragraphs. These encoding aspects may be used together in embodiments for gradual decoding refresh.

According to the VVC standard, there are about 67 possible intra prediction modes for a current CU. Since the reference pixels for the CUs in the intra code area of a vertical or horizontal GRA may be in the dirty area (or not yet coded), these reference pixels are considered not available for intra coded prediction and the like. An encoder for GRA needs to avoid those intra prediction modes in the clean area that would cause samples in the dirty area to be used as reference for intra prediction.

Furthermore, in order to identify an exact match at a recovery point, CUs in a clean area cannot use any coding information (e.g., reconstructed pixels, code mode, motion vectors (MVs), a reference line index (refIdx), etc.) from CUs in a dirty area. The encoder is responsible for making sure there is an exact match at a recovery point.

Often, a VVC encoder imposes restrictions on all coding tools for CUs in clean areas and ensures they will not touch any coding information in dirty area. By way of example only, coding tools can include, for example:
In-loop filters,
Intra prediction modes (directions),
Intrablock copy (IBC),
Regular inter modes with integer or fractional MVs,
All the possible merge modes, such as regular, Affine, combined inter and intra prediction (CIIP), merge with motion vector difference (MMVD), Triangle or GeoMerge, temporal motion vector prediction (TMVP), history-based motion vector prediction (HMVP), etc.
Special coding tools, such as luma mapping and chroma scaling (LMCS), Local Dual Tree, etc.

Imposing and validating the restrictions on such coding tools for CUs in a clean area can be complex and time consuming, which may lead to an expensive and inefficient encoder with GDR functionality, as compared to a regular encoder.

For example, for intra CUs in a clean area, an encoder with GDR functionality may need to check and make sure that intra predictions will not use any reference samples in a dirty area of the current picture. For inter CUs in a clean area, an encoder with GDR functionality may need to check and make sure that the (interpolated) prediction blocks will not use any reconstructed pixels in dirty areas of reference pictures. For merge mode CUs in a clean area, a encoder with GDR functionality may need to check and make sure that temporal candidates in dirty areas of reference pictures will not be included in the merge list. For affine mode CUs in a clean area, an encoder with GDR functionality may need to check and make sure that the (interpolated) prediction blocks for each of the subblocks, e.g., 4×4 subblocks, will not use any reconstructed pixels in dirty areas of reference pictures. For geometrically partitioning mode CUs in a clean area, an encoder with GDR functionality may need to perform validation at a proper stage, otherwise part of motion information may not be available. With inter CUs in a clean area, if it is necessary to build the merge list using, e.g., HMVP, an encoder with GDR functionality may need to avoid selecting the candidates associated with CUs in a dirty area of the current picture. These are just some of the draw backs of the conventional VVC approach with regard to encoding complexity, time-consuming validation processes, and the delay differential between encoding and decoding.

The approaches described herein can be carried out by one or more of any suitable device, apparatus, computing equipment, server, remote computing device, and/or the like. For instance, video or images can be encoded to a bitstream or the like by a first device and the bitstream or the like of video or images can be transmitted or otherwise communicated from such a device to another such device for decoding, or a single device may carry out the encoding, storage, and decoding of the bitstream or the like.

Described hereinbelow are some of the possible apparatuses, devices, systems, and equipment provided for carrying out any of the methods described herein, e.g., using any of the computer program code or computer-readable media described herein.

A video coder may comprise an encoder that transforms the input video into a compressed representation suited for storage/transmission, and/or a decoder is able to uncompress the compressed video representation back into a viewable form. The encoder may discard some information in the original video sequence in order to represent the video in more compact form (e.g., at a lower bitrate).

A compressed video representation may be referred to as a bitstream or a video bitstream. A video encoder and/or a video decoder may also be separate from each other, i.e. need not form a codec. The encoder may discard some information in the original video sequence in order to represent the video in a more compact form (that is, at lower bitrate).

Hybrid video codecs, for example, codecs configured to operate in accordance with International Telecommunication Union-Telecommunication Standardization Sector (ITU-T) H.263 and H.264, encode the video information in two phases. At first, pixel values in a certain picture (or “block”) are predicted for example by motion compensation techniques (finding and indicating an area in one of the previously coded video frames that corresponds closely to the block being coded) or by spatial means (using the pixel values around the block to be coded in a specified manner). Secondly, the prediction error, that is, the difference between the predicted block of pixels and the original block of pixels, is coded. This coding may be done by transforming the difference in pixel values using a specified transform (e.g., Discrete Cosine Transform (DCT) or a variant of it), quantizing the coefficients and entropy coding the quantized coefficients. By varying the fidelity of the quantization process, the encoder can control the balance between the accuracy of the pixel representation (picture quality) and size of the resulting coded video representation (file size of transmission bitrate).

In some video codecs, such as high-efficiency video coding (HEVC), video pictures are divided into coding units (CU) covering the area of the picture. A CU consists of one of more prediction units (PU) defining the prediction process for the samples within the CU and one or more transform units (TU) defining the prediction error coding process for the samples in the CU. A CU may consist of a square block of samples with a size selectable from a predefined set of possible CU sizes. A CU with the maximum allowed size may be named as CTU (coding tree unit) and the video picture is divided into non-overlapping CTUs. A CTU can be further split into a combination of smaller CUs, e.g., by recursively splitting the CTU and resultant CUs. Each resulting CU may have at least one PU and at least one TU associated with it. Each PU and TU can be further split into smaller PUs and TUs in order to increase granularity of the prediction and prediction error coding processes, respectively. Each PU has prediction information associated with it defining what kind of a prediction is to be applied for the pixels within that PU (e.g., motion vector information for inter-predicted PUs and intra prediction directionality information for intra predicted PUs).

Similarly, each TU is associated with information describing the prediction error decoding process for the samples within the TU (including, e.g., discrete cosine transform (DCT) coefficient information). It may be signaled at the CU level whether prediction error coding is applied or not for each CU. In the case there is no prediction errors residual associated with the CU, it can be considered there are no TUs for the CU. The division of the image into CUs, and division of CUs into PUs and TUs may be signaled in the bitstream allowing the decoder to reproduce the intended structure of these units.

The decoder reconstructs the output video by applying prediction techniques similar to the encoder to form a predicted representation of the pixel blocks (using the motion or spatial information created by the encoder and stored in the compressed representation) and prediction error decoding (inverse operation of the prediction error coding recovering the quantized prediction error signal in the spatial pixel domain). After applying prediction and prediction error decoding techniques, the decoder sums up the prediction and prediction error signals (pixel values) to form the output video frame. The decoder (and encoder) can also apply additional filtering to improve the quality of the output video before passing it for display and/or storing it as prediction reference for the forthcoming frames in the video sequence.

The filtering performed in the decoder and/or in the encoder may for example include one more of the following: deblocking, sample adaptive offset (SAO), and/or adaptive loop filtering (ALF).

An encoder may have means to apply the filtering except across certain boundaries where the filtering is turned off. The encoder may indicate in or along the bitstream the boundaries across which the filtering is turned off. For example, the encoder may include one or more syntax elements in one or more parameter sets for indicating that filtering is turned off across certain indicated boundaries. The boundaries across the filtering may be turned off as indicated by an encoder may for example include (but are not necessarily limited to) subpicture, slice, tile, and/or virtual boundaries. A virtual boundary may be indicated as a horizontal or vertical boundary at an indicated sample row or sample column position, respectively, that crosses the picture. A decoder may decode from or along the bitstream the boundaries across which the filtering is turned off. For example, the decoder may decode one or more syntax elements from one or more parameter sets for determining that filtering is turned off across certain indicated boundaries.

A Decoded Picture Buffer (DPB) may be used in the encoder and/or in the decoder. There are at least two reasons to buffer decoded pictures, for references in inter prediction and for reordering decoded pictures into output order. As H.264/AVC and HEVC provide a great deal of flexibility for both reference picture marking and output reordering, separate buffers for reference picture buffering and output picture buffering may waste memory resources. Hence, the DPB may include a unified decoded picture buffering process for reference pictures and output reordering. A decoded picture may be removed from the DPB when it is no longer used as a reference and is not needed for output.

In the current video coding design (e.g., AVC, HEVC and VVC), a coded video sequence consists of intra coded pictures (e.g., I picture) and inter coded pictures (e.g., P and B pictures). Intra coded pictures usually use many more bits than inter coded pictures. Transmission time of such big intra coded pictures increases the encoder to decoder delay. For (ultra) low delay applications, it is desirable that all the coded pictures have similar number of bits so that the encoder to decoder delay can be reduced to around 1 picture interval. Hence, intra coded picture seems not fit for (ultra) low delay applications. However, on the other hand, an intra coded picture is indeed needed at random access point.

Video coding standards may specify the bitstream syntax and semantics as well as the decoding process for error-free bitstreams, whereas the encoding process might not be specified, but encoders may just be required to generate conforming bitstreams. Bitstream and decoder conformance can be verified with the Hypothetical Reference Decoder (HRD). The standards may contain coding tools that help in coping with transmission errors and losses, but the use of the tools in encoding may be optional and decoding process for erroneous bitstreams might not have been specified.

A syntax element may be defined as an element of data represented in the bitstream. A syntax structure may be defined as zero or more syntax elements present together in the bitstream in a specified order.

An elementary unit for the input to an encoder and the output of a decoder, respectively, in most cases is a picture. A picture given as an input to an encoder may also be referred to as a source picture, and a picture decoded by a decoded may be referred to as a decoded picture or a reconstructed picture.

The source and decoded pictures are each comprised of one or more sample arrays, such as one of the following sets of sample arrays:
Luma (Y) only (monochrome).
Luma and two chroma (YCbCr or YCgCo).
Green, Blue and Red (GBR, also known as RGB).
Arrays representing other unspecified monochrome or tri-stimulus color samplings (for example, YZX, also known as XYZ).

In the following, these arrays may be referred to as luma (or L or Y) and chroma, where the two chroma arrays may be referred to as Cb and Cr: regardless of the actual color representation method in use. The actual color representation method in use can be indicated e.g. in a coded bitstream e.g. using the Video Usability Information (VUI) syntax of HEVC or alike. A component may be defined as an array or single sample from one of the three sample arrays (luma and two chroma) or the array or a single sample of the array that compose a picture in monochrome format.

A picture may be defined to be either a frame or a field. A frame comprises a matrix of luma samples and possibly the corresponding chroma samples. A field is a set of alternate sample rows of a frame and may be used as encoder input, when the source signal is interlaced. Chroma sample arrays may be absent (and hence monochrome sampling may be in use) or chroma sample arrays may be subsampled when compared to luma sample arrays.

Some chroma formats may be summarized as follows:
In monochrome sampling there is only one sample array, which may be nominally considered the luma array.
In 4:2:0 sampling, each of the two chroma arrays has half the height and half the width of the luma array.
In 4:2:2 sampling, each of the two chroma arrays has the same height and half the width of the luma array.
In 4:4:4 sampling when no separate color planes are in use, each of the two chroma arrays has the same height and width as the luma array.

Coding formats or standards may allow to code sample arrays as separate color planes into the bitstream and respectively decode separately coded color planes from the bitstream. When separate color planes are in use, each one of them is separately processed (by the encoder and/or the decoder) as a picture with monochrome sampling.

When chroma subsampling is in use (e.g. 4:2:0 or 4:2:2 chroma sampling), the location of chroma samples with respect to luma samples may be determined in the encoder side (e.g. as pre-processing step or as part of encoding). The chroma sample positions with respect to luma sample positions may be pre-defined for example in a coding standard, such as H.264/AVC or HEVC, or may be indicated in the bitstream for example as part of VUI of H.264/AVC or HEVC.

Generally, the source video sequence(s) provided as input for encoding may either represent interlaced source content or progressive source content. Fields of opposite parity have been captured at different times for interlaced source content. Progressive source content contains captured frames. An encoder may encode fields of interlaced source content in two ways: a pair of interlaced fields may be coded into a coded frame or a field may be coded as a coded field. Likewise, an encoder may encode frames of progressive source content in two ways: a frame of progressive source content may be coded into a coded frame or a pair of coded fields. A field pair or a complementary field pair may be defined as two fields next to each other in decoding and/or output order, having opposite parity (i.e. one being a top field and another being a bottom field) and neither belonging to any other complementary field pair. Some video coding standards or schemes allow mixing of coded frames and coded fields in the same coded video sequence. Moreover, predicting a coded field from a field in a coded frame and/or predicting a coded frame for a complementary field pair (coded as fields) may be enabled in encoding and/or decoding.

Partitioning may be defined as a division of a set into subsets such that each element of the set is in exactly one of the subsets.

Some codecs use a concept of picture order count (POC). A value of POC is derived for each picture and is non-decreasing with increasing picture position in output order. POC therefore indicates the output order of pictures. POC may be used in the decoding process for example for implicit scaling of motion vectors and for reference picture list initialization. Furthermore, POC may be used in the verification of output order conformance.

An elementary unit for the output of encoders of some coding formats, such as HEVC and VVC, and the input of decoders of some coding formats, such as HEVC and VVC, is a Network Abstraction Layer (NAL) unit. For transport over packet-oriented networks or storage into structured files, NAL units may be encapsulated into packets or similar structures.

A byte stream format may be specified for NAL unit streams for transmission or storage environments that do not provide framing structures. The byte stream format separates NAL units from each other by attaching a start code in front of each NAL unit. To avoid false detection of NAL unit boundaries, encoders may run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention may always be performed regardless of whether the byte stream format is in use or not.

A NAL unit may be defined as a syntax structure containing an indication of the type of data to follow and bytes containing that data in the form of a raw byte sequence payload (RBSP) interspersed as necessary with emulation prevention bytes. A RBSP may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

NAL units consist of a header and payload. In VVC, a two-byte NAL unit header is used for all specified NAL unit types, while in other codecs NAL unit header may be similar to that in VVC.

In VVC, the NAL unit header comprises a five-bit NAL unit type indication (nal_unit_type), a three-bit nuh_temporal_id_plus1 indication for temporal level or sub-layer (may be required to be greater than or equal to 1) and a six-bit nuh_layer_id syntax element. The nuh_temporal_id_plus1 syntax clement may be regarded as a temporal identifier for the NAL unit, and a zero-based TemporalId variable may be derived as follows: TemporalId=nuh_temporal_id_plus1−1. The abbreviation TID may be used to interchangeably with the TemporalId variable. TemporalId equal to 0 corresponds to the lowest temporal level. The value of nuh_temporal_id_plus1 is required to be non-zero in order to avoid start code emulation involving the two NAL unit header bytes. The bitstream created by excluding all VCL NAL units having a TemporalId greater than or equal to a selected value and including all other VCL NAL units remains conforming. Consequently, a picture having TemporalId equal to tid_value does not use any picture having a TemporalId greater than tid_value as inter prediction reference. A sub-layer or a temporal sub-layer may be defined to be a temporal scalable layer (or a temporal layer, TL) of a temporal scalable bitstream. Such temporal scalable layer may comprise VCL NAL units with a particular value of the TemporalId variable and the associated non-VCL NAL units. nuh_layer_id can be understood as a scalability layer identifier.

NAL units can be categorized into Video Coding Layer (VCL) NAL units and non-VCL NAL units. VCL NAL units may be coded slice NAL units. In HEVC and VVC, VCL NAL units contain syntax elements representing one or more CUs. In HEVC and VVC, the NAL unit type value within a certain range indicates a VCL NAL unit, and the VCL NAL unit type may indicate a picture type.

A non-VCL NAL unit may be for example one of the following types: a video parameter set (VPS), a sequence parameter set (SPS), a picture parameter set (PPS), an adaptation parameter set (APS), a supplemental enhancement information (SEI) NAL unit, a picture header (PH) NAL unit, an end of sequence NAL unit, an end of bitstream NAL unit, or a filler data NAL unit. Parameter sets may be needed for the reconstruction of decoded pictures, whereas many of the other non-VCL NAL units might not be necessary for the reconstruction of decoded sample values.

Some coding formats specify parameter sets that may carry parameter values needed for the decoding or reconstruction of decoded pictures. An example of parameter sets is described in this paragraph, but it needs to be understood that embodiments apply to any other parameter set definitions and relations too. The relationship and hierarchy between video parameter set (VPS), sequence parameter set (SPS), and picture parameter set (PPS) may be described as follows. VPS resides one level above SPS in the parameter set hierarchy. VPS may include parameters that are common across all layers in the entire coded video sequence or describe relations between layers. SPS includes the parameters that are common and remain unchanged for all slices in a particular layer in the entire coded video sequence. In addition to the SPS parameters that may be needed by the decoding process, the sequence parameter set may optionally contain video usability information (VUI), which includes parameters that may be important for buffering, picture output timing, rendering, and resource reservation. It may be possible to share an SPS by multiple layers. PPS includes the parameters that are common and remain unchanged for all slices of a coded picture and are likely to be shared by many coded pictures.

Many instances of parameter sets may be allowed in a bitstream, and each instance may be identified with a unique identifier. In order to limit the memory usage needed for parameter sets, the value range for parameter set identifiers has been limited. Each slice header (in HEVC) or each picture header (in VVC) includes the identifier of the picture parameter set that is active for the decoding of the picture that contains the slice or the picture, respectively, and each picture parameter set contains the identifier of the active sequence parameter set. Consequently, the transmission of picture and sequence parameter sets does not have to be accurately synchronized with the transmission of slices. Instead, it is sufficient that the active sequence and picture parameter sets are received at any moment before they are referenced, which allows transmission of parameter sets “out-of-band” using a more reliable transmission mechanism compared to the protocols used for the slice data. For example, parameter sets can be included as a media parameter in the session description for Real-time Transport Protocol (RTP) sessions. If parameter sets are transmitted in-band, they can be repeated to improve error robustness.

Out-of-band transmission, signaling or storage can additionally or alternatively be used for other purposes than tolerance against transmission errors, such as case of access or session negotiation. For example, a sample entry of a track in a file conforming to the ISO Base Media File Format may comprise parameter sets, while the coded data in the bitstream is stored elsewhere in the file or in another file. The phrase along the bitstream (e.g. indicating along the bitstream) may be used in claims and described embodiments to refer to out-of-band transmission, signaling, or storage in a manner that the out-of-band data is associated with the bitstream. The phrase decoding along the bitstream or alike may refer to decoding the referred out-of-band data (which may be obtained from out-of-band transmission, signaling, or storage) that is associated with the bitstream.

A parameter set may be activated by a reference from a slice or from another active parameter set or in some cases from another syntax structure. A parameter set may be activated when it is referenced e.g. through its identifier. For example, a header of an image segment, such as a slice header, may contain an identifier of the PPS (a.k.a. PPS ID) that is activated for decoding the coded picture containing the image segment. A PPS may contain an identifier of the SPS that is activated, when the PPS is activated. An activation of a parameter set of a particular type may cause the deactivation of the previously active parameter set of the same type. The parameters of an activated parameter set may be used or referenced in the decoding process.

Instead of or in addition to parameter sets at different hierarchy levels (e.g. sequence and picture), video coding formats may include header syntax structures, such as a sequence header or a picture header. A sequence header may precede any other data of the coded video sequence in the bitstream order. A picture header may precede any coded video data for the picture in the bitstream order.

In VVC, a picture header (PH) may be defined as a syntax structure containing syntax elements that apply to all slices of a coded picture. In other words, contains information that is common for all slices of the coded picture associated with the PH. A picture header syntax structure may be contained in a picture header RBSP, which may be contained in a picture header NAL unit.

An SEI NAL unit may contain one or more SEI messages, which might not be required for the decoding of output pictures but may assist in related processes, such as picture output timing, rendering, error detection, error concealment, and resource reservation. Several SEI messages are specified e.g. in H.264/AVC, HEVC, VVC, and VSEI (ITU-T Recommendation H.274| ISO/IEC 23002-7 Versatile supplemental enhancement information messages for coded video bitstreams). User data SEI message(s) enable organizations and companies to specify SEI messages for their own use. Standards, such as H.264/AVC and HEVC, may contain the syntax and semantics for the specified SEI messages but might not specify a process for handling the messages in the recipient. Consequently, encoders may be required to follow the standard specifying the SEI message when they create SEI messages. Decoders might not be required to process SEI messages for output order conformance. One of the reasons to include the syntax and semantics of SEI messages in standard(s) is to allow different system specifications to interpret the supplemental information identically and hence interoperate. System specifications may require the use of particular SEI messages both in the encoding end and in the decoding end, and additionally the process for handling particular SEI messages in the recipient may be specified.

In some video coding specifications, such as HEVC and VVC, there are two types of SEI NAL units, namely the suffix SEI NAL unit and the prefix SEI NAL unit, having a different nal_unit_type value from each other. The SEI message(s) contained in a suffix SEI NAL unit are associated with the VCL NAL unit preceding, in decoding order, the suffix SEI NAL unit. The SEI message(s) contained in a prefix SEI NAL unit are associated with the VCL NAL unit following, in decoding order, the prefix SEI NAL unit.

A hash function may be defined as any function that can be used to map digital data of arbitrary size to digital data of fixed size, with slight differences in input data possibly producing big differences in output data. A cryptographic hash function may be defined as a hash function that is intended to be practically impossible to invert, i.e. to create the input data based on the hash value alone. Cryptographic hash function may comprise e.g. the MD5 function. An MD5 value may be a null-terminated string of UTF-8 characters containing a base64 encoded MD5 digest of the input data. One method of calculating the string is specified in IETF RFC 1864. It should be understood that instead of or in addition to MD5, other types of integrity check schemes could be used in various embodiments, such as different forms of the cyclic redundancy check (CRC), such as the CRC scheme used in ITU-T Recommendation H.271.

A checksum or hash sum may be defined as a small-size datum from an arbitrary block of digital data which may be used for the purpose of detecting errors which may have been introduced during its transmission or storage. The actual procedure which yields the checksum, given a data input may be called a checksum function or checksum algorithm. A checksum algorithm will usually output a significantly different value, even for small changes made to the input. This is especially true of cryptographic hash functions, which may be used to detect many data corruption errors and verify overall data integrity: if the computed checksum for the current data input matches the stored value of a previously computed checksum, there is a high probability the data has not been altered or corrupted. The term checksum may be defined to be equivalent to a cryptographic hash value or alike.

The syntax of a decoded picture hash SEI message may be specified as follows. It needs to be understood that embodiments are not limited to this syntax only, but apply equally to any syntax with similar functionality.

| | Descriptor |
|---|---|
| decoded_picture_hash( payloadSize ) { | |
| dph_sei_hash_type | u(8) |
| dph_sei_single_component_flag | u(1) |
| dph_sei_reserved_zero_7bits | u(7) |
| for( cIdx = 0; cIdx < ( dph_sei_single_component_flag ? | |
| 1 : 3 ); cIdx++ ) | |
| if( dph_sei_hash_type = = 0 ) | |
| for( i = 0; i < 16; i++) | |
| dph_sei_picture_md5[ cIdx ][ i ] | b(8) |
| else if(dph_sei_hash_type = = 1 ) | |
| dph_sei_picture_crc[ cIdx ] | u(16) |
| else if(dph_sei_hash_type = = 2 ) | |
| dph_sei_picture_checksum [ cIdx ] | u(32) |
| } | |

The semantics of a decoded picture hash SEI message may be specified as follows. It needs to be understood that embodiments are not limited to this semantics only, but apply equally to any semantics with similar functionality

This message provides a hash for each colour component of the current decoded picture. Use of this SEI message requires the definition of the following variables:
A picture width and picture height in units of luma samples, denoted herein by PicWidthInLumaSamples and PicHeightInLumaSamples, respectively.
A chroma format indicator, denoted herein by ChromaFormatIdc.
A bit depth for the samples of the luma component, denoted herein by BitDepth_{Y}, and when ChromaFormatIdc is not equal to 0, a bit depth for the samples of the two associated chroma components, denoted herein by BitDepth_{C}.
For each colour component cIdx, an array of samples ComponentSample[cIdx][x][y].

Prior to computing the hash, the decoded picture data are arranged into one or three strings of bytes called pictureData[cIdx] of lengths dataLen[cIdx] as follows:

```
for( cIdx = 0; cIdx < dph_sei_single_component_flag ? 1 : 3; cIdx++ ) {
  if( cIdx == 0 ) {
    compWidth[ cIdx ] = PicWidthInLumaSamples
    compHeight[ cIdx ] = PicHeightInLumaSamples
    compDepth[ cIdx ] = BitDepth_{Y}
  } else {
    compWidth[ cIdx ] = PicWidthInLumaSamples / SubWidthC
    compHeight[ cIdx ] = PicHeightInLumaSamples / SubHeightC
    compDepth[ cIdx ] = BitDepth_{C}
  }
  iLen = 0
  for( y = 0; y < compHeight[ cIdx ]; y++ ) /* raster scan order */
    for( x = 0; x < compWidth[ cIdx ]; x++) {
      pictureData[ cIdx ][ iLen++ ] = ComponentSample[ cIdx ][ x ][ y ] & 0xFF
      if( compDepth[ cIdx ] > 8 )
        pictureData[ cIdx ][ iLen++ ] = ComponentSample[ cIdx ][ x ][ y ] >> 8
    }
  dataLen[ cIdx ] = iLen
}
```

where ComponentSample[cIdx] is a 2-dimension array of the decoded sample values of a component of a decoded picture.
dph_sei_hash_type indicates the method used to calculate the checksum as specified in the table below. Decoders shall ignore decoded picture hash SEI messages that contain reserved values of dph_sei_hash_type.
   Interpretation of dph_sei_hash_type

| dph_sei_hash_type | Method |
|---|---|
| 0 | MD5 (IETF RFC 1321) |
| 1 | CRC |
| 2 | Checksum |

dph_sei_single_component_flag equal to 1 specifies that the picture associated with the decoded picture hash SEI message contains a single colour component. dph_sei_single_component_flag equal to 0 specifies that the picture associated with the decoded picture hash SEI message contains three colour components. The value of dph_sei_single_component_flag shall be equal to (ChromaFormatIdc==0).
dph_sei_reserved_zero_7bits shall be equal to 0. Values greater than 0 for dph_sei_reserved_zero_7bits are reserved for future use by ITU-T|ISO/IEC and shall not be present in payload data conforming to this version of this Specification. Decoders conforming to this version of this Specification shall ignore the value of dph_sei_reserved_zero_7bits.
dph_sei_picture_md5[cIdx][i] is the 16-byte MD5 hash of the cIdx-th colour component of the decoded picture. The value of dph_sei_picture_md5[cIdx][i] shall be equal to the value of digestVal[cIdx] obtained as follows, using the MD5 functions defined in IETF RFC 1321:
   MD5Init(context)
   MD5Update(context, pictureData[cIdx], dataLen[cIdx])
   MD5Final(digestVal[cIdx], context)
dph_sei_picture_crc[cIdx] is the cyclic redundancy check (CRC) of the colour component cIdx of the decoded picture. The value of dph_sei_picture_crc[cIdx] shall be equal to the value of crcVal[cIdx] obtained as follows:

```
crc = 0xFFFF
pictureData[ cIdx ][ dataLen[ cIdx ] ] = 0
pictureData[ cIdx ][ dataLen[ cIdx ] + 1 ] = 0
for( bitIdx = 0; bitIdx < ( dataLen[ cIdx ] + 2 ) * 8; bitIdx++ ) {
  dataByte = pictureData[ cIdx ][ bitIdx >> 3 ]
  crcMsb = ( crc >> 15 ) & 1
  bitVal = ( dataByte >> ( 7 − ( bitIdx & 7 ) ) ) & 1
  crc = ( ( ( crc << 1 ) + bitVal ) & 0xFFFF ) \hat{ } ( crcMsb * 0x1021 )
}
crcVal[ cIdx ] = crc
```

NOTE—The same CRC specification is found in Rec. ITU-T H.271.
   dph_sei_picture_checksum[cIdx] is the checksum of the colour component cIdx of the decoded picture. The value of dph_sei_picture_checksum[cIdx] shall be equal to the value of checksum Val[cIdx] obtained as follows:

```
sum = 0
for( y = 0; y < compHeight[ cIdx ]; y++ )
  for( x = 0; x < compWidth[ cIdx ]; x++ ) {
    xorMask = ( x & 0xFF ) \hat{ } ( y & 0xFF ) \hat{ } ( x >> 8 ) \hat{ } ( y >> 8 )
    sum = ( sum + ( ( ComponentSample[ cIdx ][ y * compWidth[ cIdx ] +x ] & 0xFF ) \hat{ }xorMask ) ) & 0xF [symbol]
    if( compDepth[ cIdx ] > 8 )
      sum = ( sum + ( ( ComponentSample[ cIdx ][ y * compWidth[ cIdx ] + x ] >> 8 ) \hat{ }
xorMask ) ) & 0xFFFFFFFF
  }
checksumVal[ cIdx ] = sum [symbol]
indicates data missing or illegible when filed
```

Decoded picture hash SEI message enables indicating separate hashes (one for each color component) using every pixel in the picture.

As similarly stated above, in Versatile Video Coding (VVC) at the time of this application a decoded picture hash calculated based upon the entire picture is used to verify if the reconstructed pictures at encoder and decoder are matched or not.

The picture-based hash may not be suitable for some applications, such as GDR, subpicture, 360° videos, etc, where only local region(s) of a picture are of interest. For example, for GDR applications, to meet the exact match requirement, only the clean (or refreshed) areas of GDR pictures and recovering pictures need to be the same at encoder and decoder. For the case of subpicture, maybe only some of subpictures need to be checked. For 360° videos, maybe, only one local region (or viewpoint) is of interest.

A region-based hash is therefore proposed, in which hashes are generated for only specific and/or interest region(s) of a picture. And decoder only needs to check the hashes for those regions of reconstructed pictures.

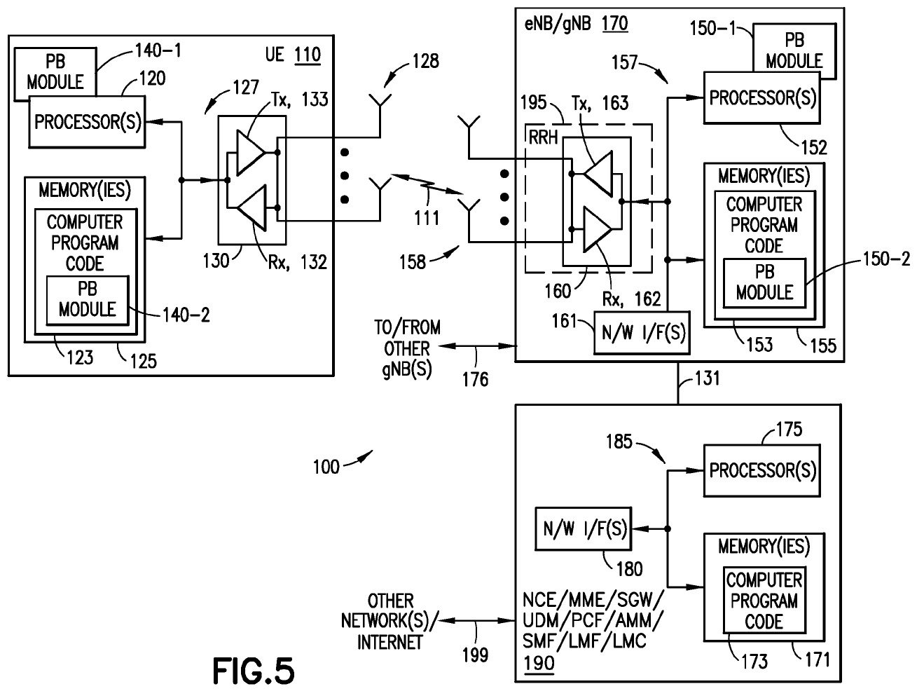

Before describing the example embodiments of the invention in further detail reference is made to FIG. 5. FIG. 5 shows a block diagram of one possible and non-limiting exemplary system in which the exemplary embodiments may be practiced.

As shown in FIG. 5, a user equipment (UE) 110 is in wireless communication with a wireless network 100. A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver Rx, 132 and a transmitter Tx 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 may include a PB (picture block) Module 140 which is configured to perform the example embodiments of the invention as described herein. The PB Module 140 may be implemented in hardware by itself of as part of the processors and/or the computer program code of the UE 110. The PB Module 140 comprising one of or both parts 140-1 and/or 140-2, which may be implemented in a number of ways. The PB Module 140 may be implemented in hardware as PB Module 140-1, such as being implemented as part of the one or more processors 120. The PB Module 140-1 may be implemented also as an integrated circuit or through other hardware such as a programmable gate array. In another example, the PB Module 140 may be implemented as PB Module 140-2, which is implemented as computer program code 123 and is executed by the one or more processors 120. Further, it is noted that the PB Modules 140-1 and/or 140-2 are optional. For instance, the one or more memories 125 and the computer program code 123 may be configured, with the one or more processors 120, to cause the user equipment 110 to perform one or more of the operations as described herein. The UE 110 communicates with gNB 170 via a wireless link 111.

The gNB 170 (NR/5G Node B or possibly an evolved NB) is a base station (e.g., for LTE, long term evolution) that provides access by wireless devices such as the UE 110 to the wireless network 100. The gNB 170 includes one or more processors 152, one or more memories 155, one or more network interfaces (N/W I/F(s)) 161, and one or more transceivers 160 interconnected through one or more buses 157. Each of the one or more transceivers 160 includes a receiver Rx 162 and a transmitter Tx 163. The one or more transceivers 160 are connected to one or more antennas 158. The one or more memories 155 include computer program code 153. The gNB 170 includes an PB Module 150 which is configured to perform example embodiments of the invention as described herein. The PB Module 150 may comprise one of or both parts 150-1 and/or 150-2, which may be implemented in a number of ways. The PB Module 150 may be implemented in hardware by itself or as part of the processors and/or the computer program code of the gNB 170. PB Module 150-1, such as being implemented as part of the one or more processors 152. The PB Module 150-1 may be implemented also as an integrated circuit or through other hardware such as a programmable gate array. In another example, the PB Module 150 may be implemented as PB Module 150-2, which is implemented as computer program code 153 and is executed by the one or more processors 152. Further, it is noted that the PB Modules 150-1 and/or 150-2 are optional. For instance, the one or more memories 155 and the computer program code 153 may be configured to cause, with the one or more processors 152, the gNB 170 to perform one or more of the operations as described herein. The one or more network interfaces 161 communicate over a network such as via the links 176 and 131. Two or more gNB 170 may communicate using, e.g., link 176. The link 176 may be wired or wireless or both and may implement, e.g., an X2 interface.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the gNB 170 being physically in a different location from the RRH, and the one or more buses 157 could be implemented in part as fiber optic cable to connect the other elements of the gNB 170 to the RRH 195.

It is noted that description herein indicates that “cells” perform functions, but it should be clear that the gNB that forms the cell will perform the functions. The cell makes up part of a gNB. That is, there can be multiple cells per gNB.

The wireless network 100 may include a NCE/MME/SGW/UDM/PCF/AMM/SMF/LMF/LMC 190, which can comprise a network control element (NCE), and/or serving gateway (SGW) 190, and/or MME (Mobility Management Entity) and/or SGW (Serving Gateway) functionality, and/or user data management functionality (UDM), and/or PCF (Policy Control) functionality, and/or Access and Mobility (AMF) functionality, and/or Session Management (SMF) functionality, Location Management Function (LMF), Location Management Component (LMC) and/or Authentication Server (AUSF) functionality and which provides connectivity with a further network, such as a telephone network and/or a data communications network (e.g., the Internet), and which is configured to perform any 5G and/or NR operations in addition to or instead of other standards operations at the time of this application. The NCE/MME/SGW/UDM/PCF/AMM/SMF/LMF/LMC 190 is configurable to perform operations in accordance with example embodiments of the invention in any of an LTE, NR, 5G and/or any standards based communication technologies being performed or discussed at the time of this application.

The gNB 170 is coupled via a link 131 to the NCE/MME/SGW/UDM/PCF/AMM/SMF/LMF/LMC 190. The link 131 may be implemented as, e.g., an SI interface or N2 interface. The NCE/MME/SGW/UDM/PCF/AMM/SMF/LMF/LMC 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the NCE/MME/SGW/UDM/PCF/AMM/SMF/LMF/LMC 190 to perform one or more operations. In addition, the NCE/MME/SGW/UDM/PCF/AMM/SMF/LMF/LMC 190, as are the other devices, is equipped to perform operations of such as by controlling the UE 110 and/or gNB 170 for 5G and/or NR operations in addition to any other standards operations implemented or discussed at the time of this application.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 r 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions and other functions as described herein to control a network device such as the UE 110, gNB 170, and/or NCE/MME/SGW/UDM/PCF/AMM/SMF/LMF/LMC 190 as in FIG. 5.

It is noted that functionality(ies), in accordance with example embodiments of the invention, of any devices as shown in FIG. 5 e.g., the UE 110 and/or gNB 170 can also be implemented by other network nodes, e.g., a wireless or wired relay node (a.k.a., integrated access and/or backhaul (IAB) node). In the IAB case, UE functionalities may be carried out by MT (mobile termination) part of the IAB node, and gNB functionalities by DU (Data Unit) part of the IAB node, respectively. These devices can be linked to the UE 110 as in FIG. 5 at least via the wireless link 111 and/or via the NCE/MME/SGW/UDM/PCF/AMM/SMF/LMF/LMC 190 using link 199 to Other Network(s)/Internet as in FIG. 5.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

As similarly stated above, a region-based hash is proposed in which hashes are generated for only specific and/or interest region(s) of a picture. And decoder only needs to check the hashes for those regions of reconstructed pictures.

An encoder, according to one or more embodiments, selects a region for deriving a hash based on one or more of the following:
A clean area in a GDR picture or in a recovering picture. As long as the clean areas are not contaminated by the dirty areas, exact match can be achieved at recovery point. For GDR applications, only the clean areas of GDR pictures and recovering pictures need to be the same at the encoder and the decoder. It is, therefore, disclosed herein that for GDR pictures and recovering pictures, hash is calculated for the clean areas only: or
One or more subpictures. When subpicture boundaries are treated like picture boundaries and no filtering is applied across the subpicture boundaries, the decoding of a sequence of collocated subpictures does not depend on any other subpictures. Subpictures may be extracted from one or more source bitstreams and/or merged to a destination bitstream. It is therefore meaningful that hash is calculated on subpicture basis.

According to one or more embodiments, an encoder computes a hash from the selection region and indicates the hash and the region in or along the video bitstream, e.g. in an SEI message. The region may be indicated e.g. through one of the following:
Spatial coordinates of a pre-defined point, such as the top-left corner of the region, and the width and height of the region: or
Spatial coordinates of pre-defined opposite corners, such as the top-left corner and the bottom-right corner.

In an embodiment, a decoder decodes a region-based hash and a selected region from or along the video bitstream and computes a hash value from the selected region. In an embodiment, the decoder compares the hash value decoded from or along the video bitstream with the respective hash value computed by the decoder. If the hash values are equal, the decoder concludes that the selected region is correctly decoded. If the hash values differ, the decoder concludes that the selected region is not correct, and consequently the decoder may for example request refreshing the picture from the far-end encoder and/or cease displaying decoded pictures until a picture or a selected area is correctly decoded. In an embodiment, if multiple region-based hashes and regions for the same picture are decoded from or along the video bitstream and some but not all regions are determined to be correct based on comparing respective hash values as described above, the decoder may continue displaying those regions that are correctly decoded and case displaying those regions that are not correctly decoded. This embodiment may suit subpicture-based viewport-dependent delivery, where some subpictures may fall outside of the viewport and hence not needed for displaying and/or multiple subpictures may have the same coverage at different resolutions and hence any received subpicture can be used for rendering that content coverage.

In the following paragraphs some example options are described for indicating a hash and a region from which the hash is derived in or along the video bitstream as one or more SEI messages. The options are merely examples to illustrate how to possible implement features of the embodiments. Other methods may also be used. It needs to be understood that embodiments for decoding may use the syntax and semantics example options for decoding a region-based hash and a selected region from or along the video bitstream.

### Option 1

With the proposed region-based hash, below are possible changes (identified with double brackets) in the current VVC standard and in the current VSEI (H.274) standard. On VVC side, a new SEI message is created for decoded region hash and a new section D.9.7 “Use of decoded region hash SEI message” is added. In H.274, a new section 8.19 on syntax and semantics “Decoded region hash SEI message” is added and Section 8.8.2 “Decoded picture hash SEI message semantics” is modified so that it can also provide a hash for a region of interest.

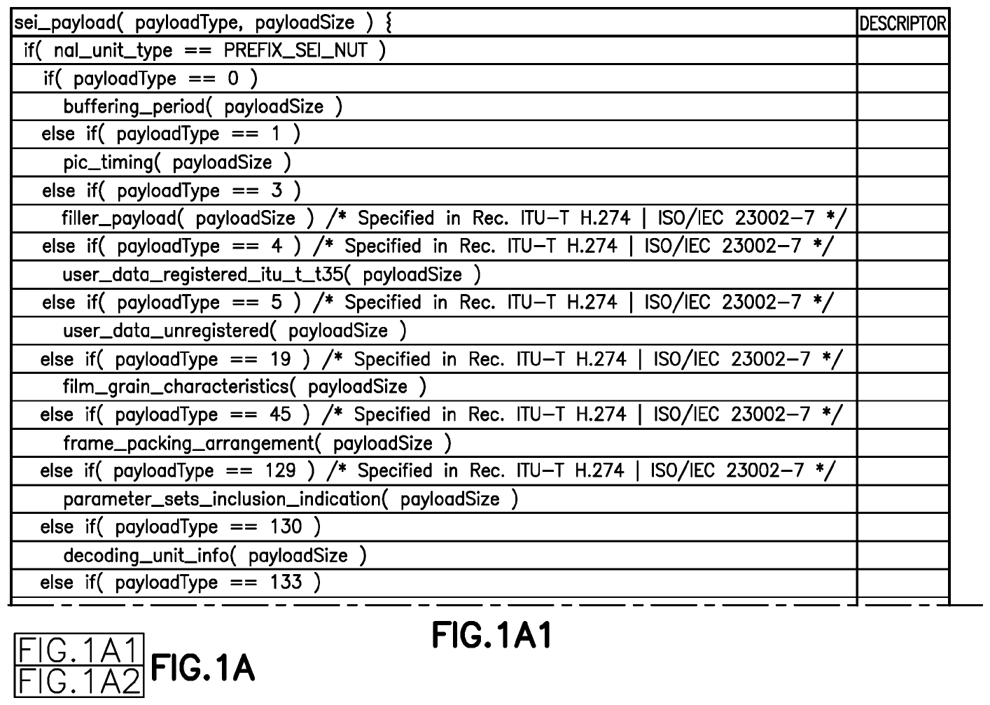

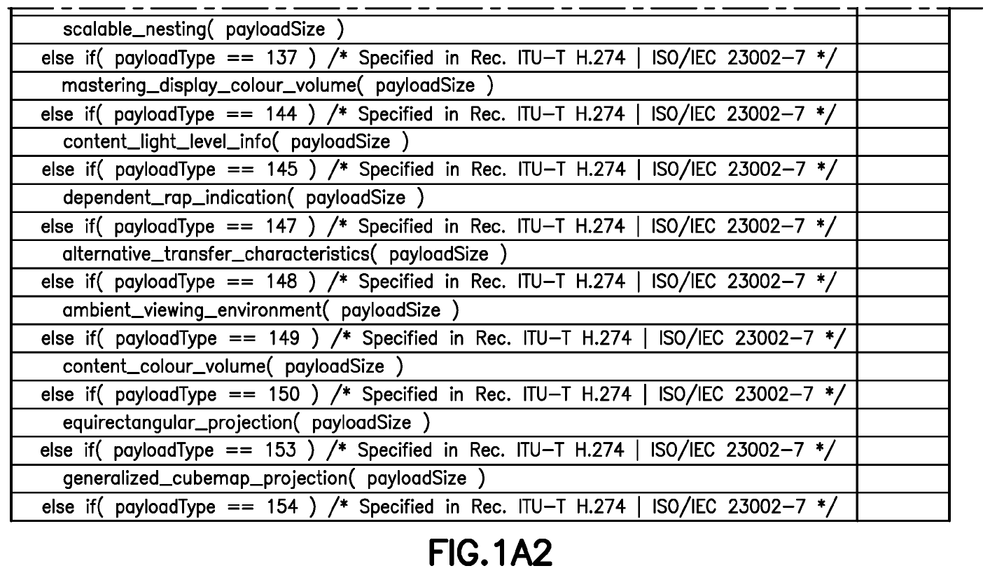

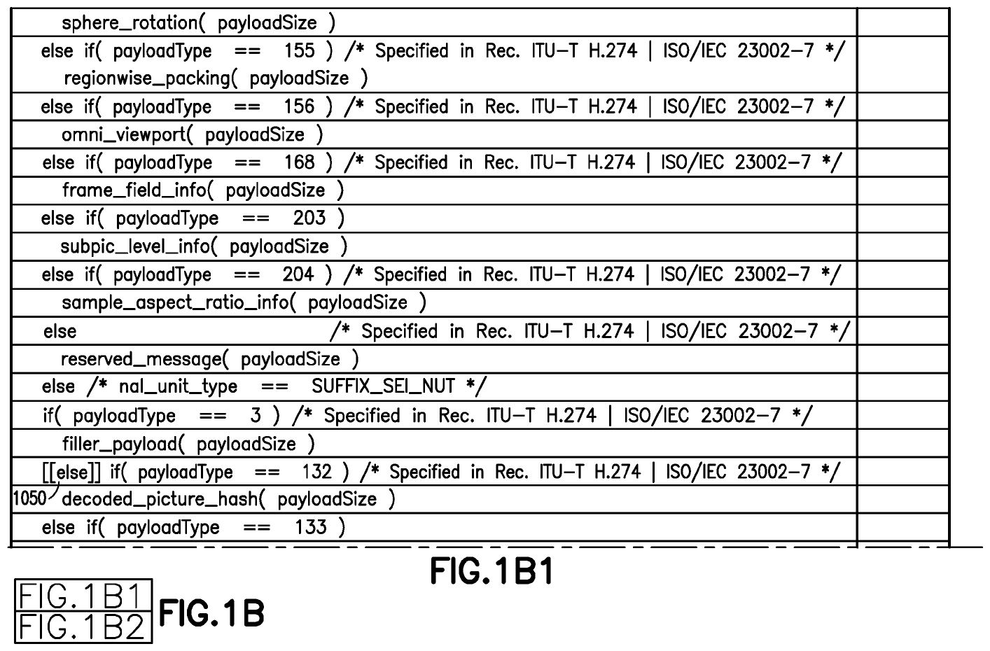

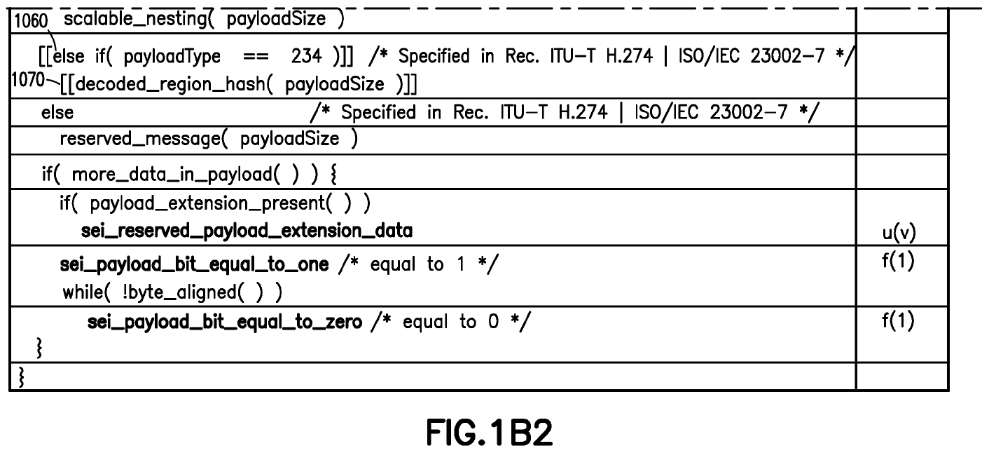

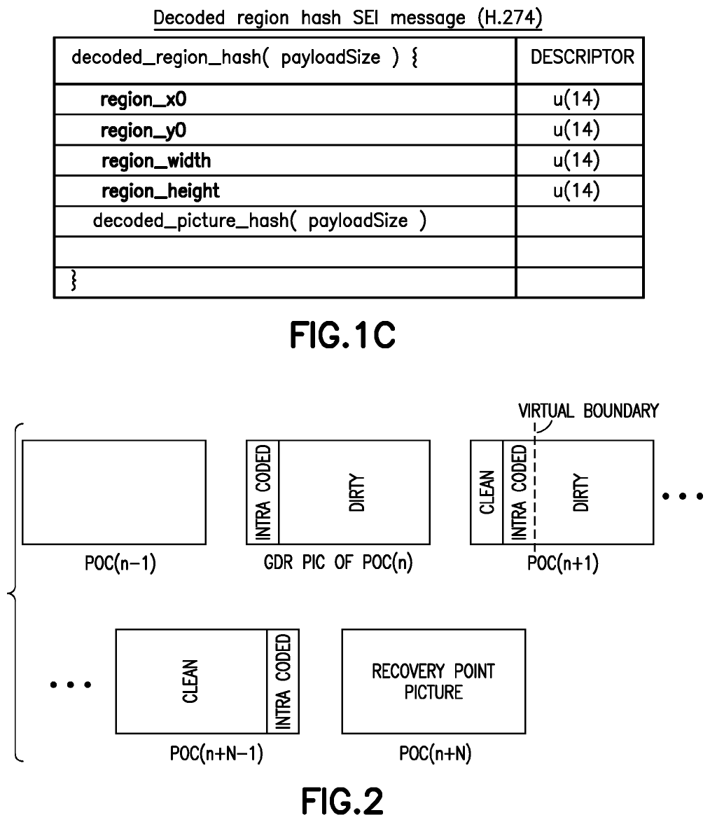

FIG. 1A and FIG. 1B each show a General SEI payload syntax of a General SEI payload with changes in accordance with an example embodiment of the invention identified by double brackets in FIG. 1B.

As shown in item 1050 of FIG. 5B there is added “else” language. As shown in item 1060 of FIG. 1B there is added “else if(payloadType==234)”, and as shown in item 11070 of FIG. 1B there is added “decoded_region_hash(payloadSize).”

FIG. 1C shows a Decoded region hash SEI message (H.274) in accordance with example embodiments of the invention. As shown in FIG. 1C a region_x0 is the horizontal offset from the top-left corner of a picture, a region_y0 is the vertical offset from the top-left corner of a picture, a region_width is the width of the specific and/or interest region, and a region_height is the height of the specific and/or interest region.

Further, it is noted that in accordance with example embodiments of the invention, in addition any of the top-left corner or a bottom-right corner coordinators can be used to describe and/or identify the region and/or region information such as a region height or region width.

These features of FIG. 1B and FIG. 1C can be used for interpreting a decoded region hash

SEI messain accordance with example embodiments of the invention.

For purposes of interpretation of the decoded region hash SEI message, the following variables are specified:
RegionX0 is set equal to region_x0;
RegionY0 is set equal to region_y0;
RegionWidth is set equal to region_width;
RegionHeight is set equal to region_height;
ChromaFormatIdc is set equal to sps_chroma_format_idc0;
BitDepth_{Y} and BitDepth_{C} are both set equal to BitDepth; and
ComponentSample[cIdx] is set to be the 2-dimension array of decoded sample values of the cIdx-th component of a decoded picture.

Also, a few changes (identified with double brackets) in section “Decoded picture hash SEI message semantics” in H.274 are needed as follows.

### 8.8.2 Decoded Picture Hash SEI Message Semantics (H.274)

The SEI message in accordance with example embodiments of the invention can provide a hash for each colour component of the current decoded picture (or region).

Use of this SEI message requires the definition of the following variables:
A region with its top-left luma sample relative to the top-left luma sample of the current picture, denoted by (RegionX0, RegionY0), and width and height, denoted by RegionWidth and RegionHeight. When RegionX0 or RegionY0 is not set, RegionX0 or RegionY0 is inferred to be equal to 0. When RegionWidth or RegionHeight is not set, Region Width or RegionHeight is inferred to be equal to PicWidthInLumaSamples or PicHeightInLumaSamples, respectively;
A chroma format indicator, denoted herein by ChromaFormatIdc;
A bit depth for the samples of the luma component, denoted herein by BitDepthY, and when ChromaFormatIdc is not equal to 0, a bit depth for the samples of the two associated chroma components, denoted herein by BitDepthC; and/or
For each colour component cIdx, an array of samples ComponentSample[cIdx][x][y].

In accordance with example embodiments of the invention prior to computing the hash, the decoded picture (or region) data are arranged into one or three strings of bytes called pictureData[cIdx] of lengths dataLen[cIdx]. This is shown as underlined as follows:

```
for( cIdx = 0; cIdx < dph_sei_single_component_flag ? 1 : 3; cIdx++ ) {
  if( cIdx = = 0 ) {
    compX0[cIdx] = RegionX0
    compY0[cIdx] = RegionY0
    compWidth[ cIdx ] = RegionWidth
    compHeight[ cIdx ] = RegionHeight
    compDepth[ cIdx ] = BitDepthY
  } else {
    compX0[cIdx] = RegionX0 / SubWidthC
    compY0[cIdx] = RegionY0 / SubWidthC
    compWidth[ cIdx ] = RegionWidth / SubWidthC
    compHeight[ cIdx ] = RegionHeight / SubWidthC
    compDepth[ cIdx ] = BitDepthC (29)
  }
  iLen = 0
  for( y = compY0[cIdx]; y < (compY0[cIdx] + compHeight[ cIdx ]); y++ ) /* raster scan order */
    for( x = compX0[cIdx]; x < (compX0[cIdx] + compWidth[ cIdx ]); x++) {
      pictureData[ cIdx ][ iLen++ ] = ComponentSample[ cIdx ][ x ][ y ] & 0xFF
      if( compDepth[ cIdx ] > 8 )
        pictureData[ cIdx ][ iLen++ ] = ComponentSample[ cIdx ][ x ][ y ] >> 8
    }
  dataLen[ cIdx ] = iLen
}
```

where ComponentSample[cIdx] is a 2-dimension array of the decoded sample values of a component of a decoded picture (or region).

dph_sei_picture_md5[cIdx][i] is the 16-byte MD5 hash of the cIdx-th colour component of the decoded picture (or region). The value of dph_sei_picture_md5[cIdx][i] shall be equal to the value of digest Val[cIdx] obtained as follows, using the MD5 functions defined in IETF RFC 1321: MD5Init(context)
MD5Update(context, pictureData[cIdx], dataLen[cIdx]) (30) M
D5Final(digestVal[cIdx], context)

dph_sei_picture_crc[cIdx] is the cyclic redundancy check (CRC) of the colour component cIdx of the decoded picture (or region). The value of dph_sei_picture_crc[cIdx] shall be equal to the value of crcVal[cIdx] obtained as follows:

```
crc = 0xFFFF
pictureData[cIdx][dataLen[cIdx]] = 0
pictureData[cIdx][dataLen[cIdx] + 1] = 0
for (bitIdx = 0; bitIdx < (dataLen[cIdx] + 2) * 8; bitIdx++) {
  dataByte = pictureData[cIdx][bitIdx >> 3]
  crcMsb = (crc >> 15) & 1
  bitVal = (dataByte >> ( 7 − bitIdx & 7))) & 1
  crc = (((crc << 1) + bitval) & 0xFFFF) \hat{ } (crcMsb * 0x1021)
}
crcVal[cIdx] = crc
```

dph_sei_picture_checksum[cIdx] is the checksum of the colour component cIdx of the decoded picture (or region). The value of dph_sei_picture_checksum[cIdx] shall be equal to the value of checksum Val[cIdx] obtained as follows:

```
  sum = 0
  for (y = compY0[cIdx]; y < ( compY0[cIdx] + compHeight[cIdx] );
  y++)
    for (x = compX0[cIdx]; x < ( compX0[cIdx] + compWidth[cIdx] );
    x++) {
        xorMask = (x & 0xFF) \hat{ } (y & 0xFF) \hat{ } (x >> 8) \hat{ }
        (y >> 8)
        sum = (sum + ((ComponentSample[cIdx][y * compWidth[cIdx] + x] & 0xFF) \hat{ }
        xorMask)) &
0xFFFFFFFF
      if (compDepth[cIdx] > 8)
      sum = (sum + ((ComponentSample[cIdx][y * compWidth[cIdx] + x] >> 8) \hat{ }
        xorMask)) & 0xFFFFFFFF
    }
  checksumVal[cIdx] = sum
```

### Option 2

Another embodiment is to define regional_nesting SEI message, and add a new section D.9.7 “Use of the decoded picture hash SEI message as a region-nested SEI message” in VVC spec. In H.274, a new section 8.19 on syntax and semantics “Decoded regional nesting hash SEI message” is added, and Section 8.8.2 “Decoded picture hash SEI message semantics” is modified so that it can also provide a hash for a region of interest.

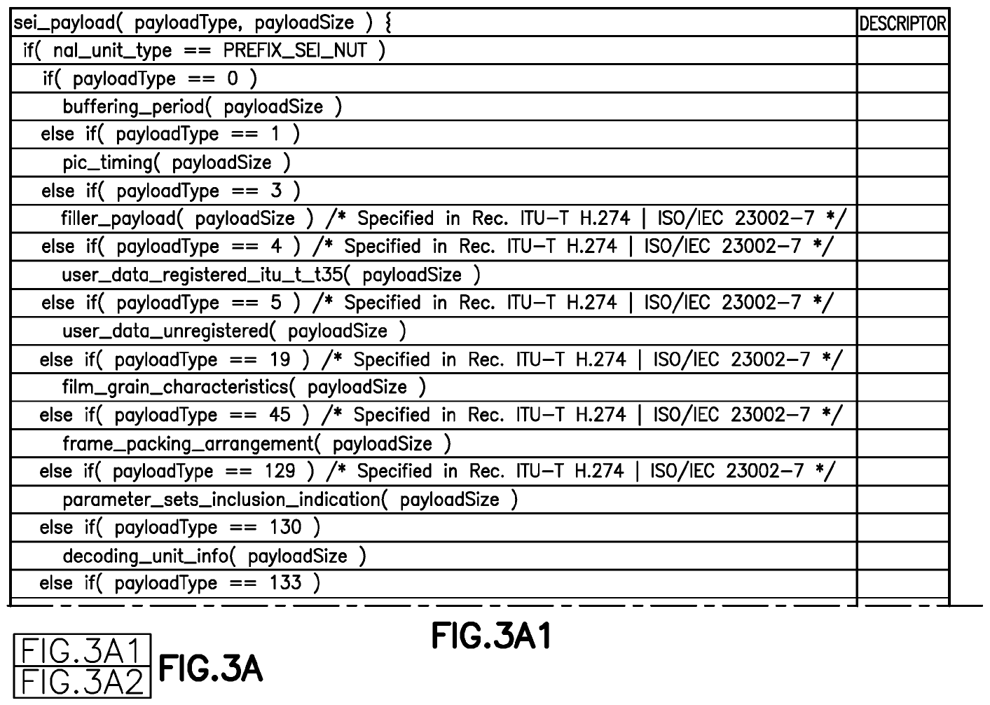

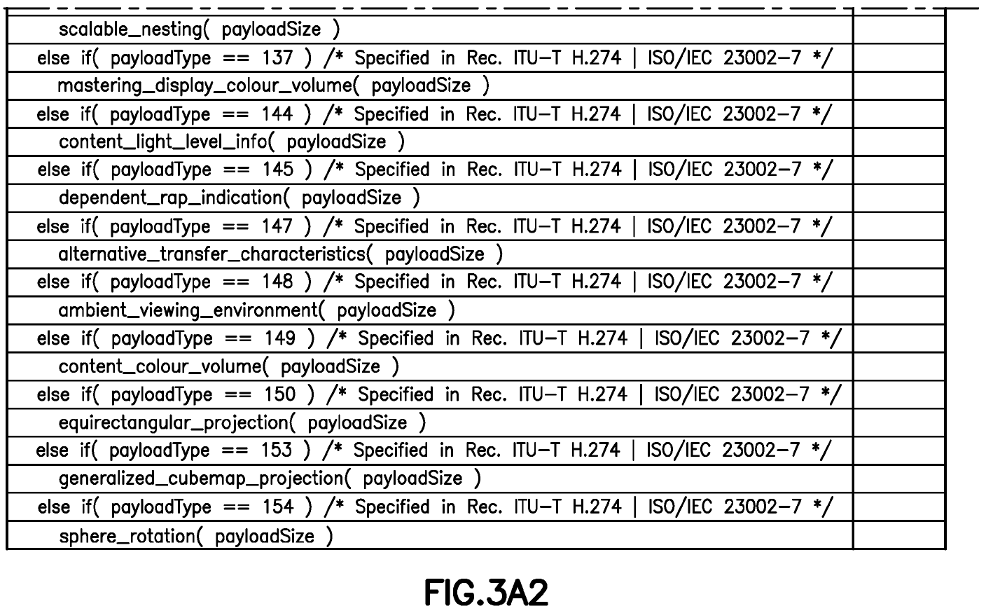

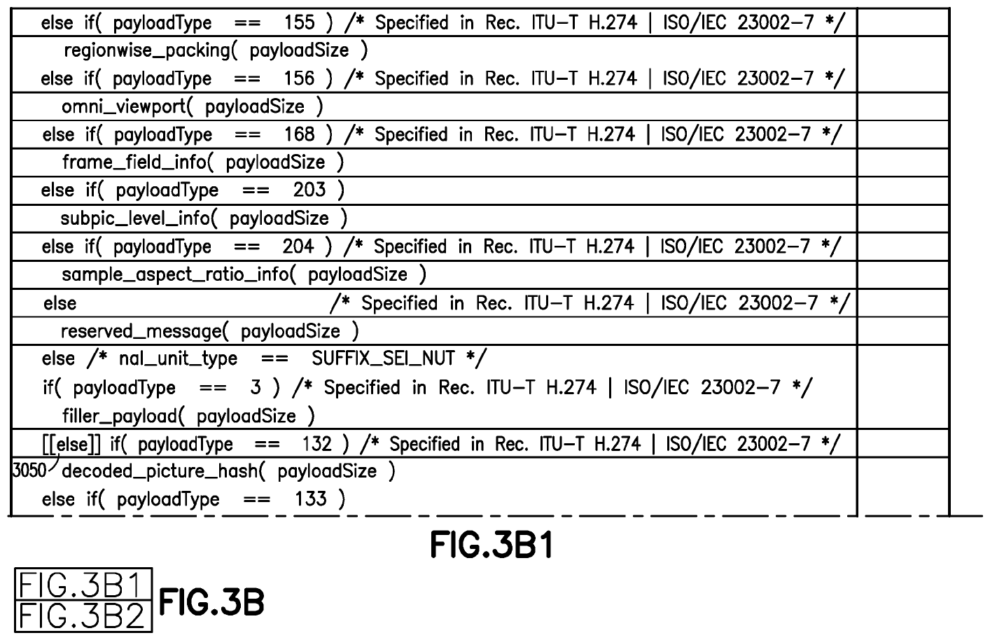

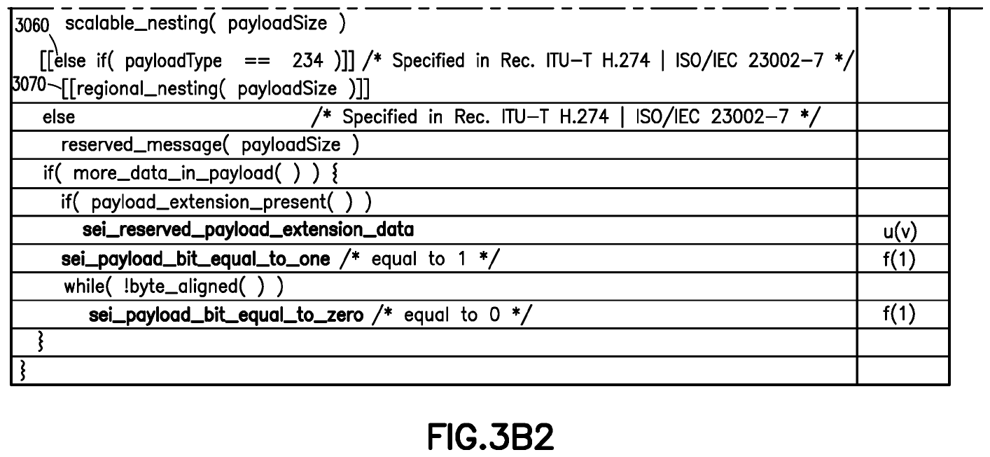

FIG. 3A and FIG. 3B shows changes to a General SEI payload syntax (H.266) of a General SEI payload in accordance with another example embodiment of the invention. Example embodiments of the invention are shown using double brackets in FIG. 3B.

As shown in item 3050 of FIG. 3B there is added “else” language. As shown in item 3060 of FIG. 3B there is added “else if(payloadType==234)”, and as shown in item 3070 of FIG. 3B there is added “regional_nesting(payloadSize).”

Note that originally, “regional_nesting” is defined in H.265 and it is prefix SEI message. Since picture hash SEI is suffix SEI message and hash is calculated based on the current reconstructed picture, regional_nesting SEI message is added as suffix SEI. But, regional_nesting SEI message may not be limited to suffix only. If it is defined as prefix SEI message, the above syntax table will be modified accordingly.

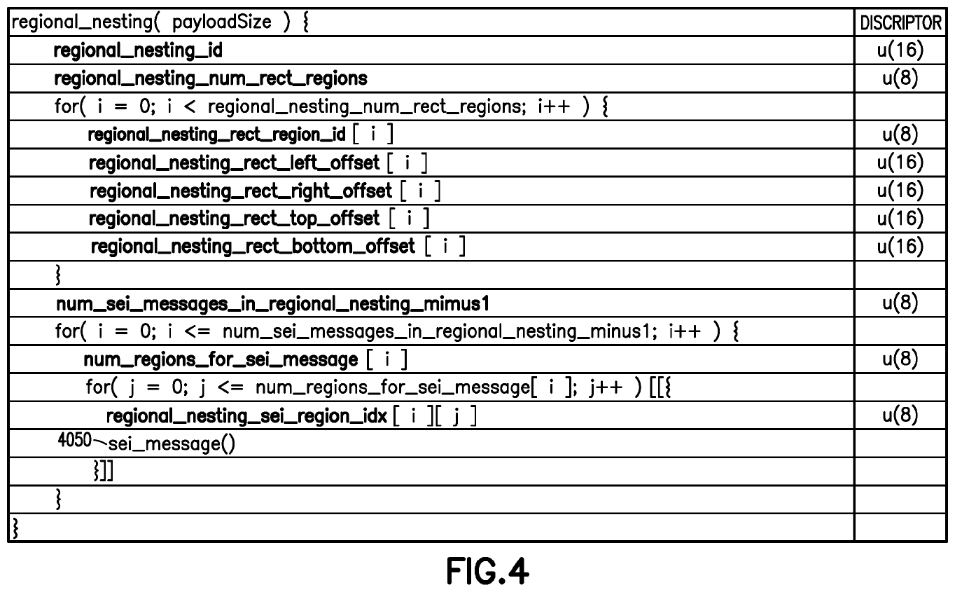

FIG. 4 shows Decoded regional nesting SEI message (H.274) in accordance with an example embodiment of the invention. As shown in FIG. 4:
regional_nesting_rect_region_id[i] specifies the identifier for the i-th rectangular region specified in the regional nesting SEI message:
regional_nesting_rect_left_offset[i], regional_nesting_rect_right_offset, regional_nesting_rect_top_offset, and regional_nesting_rect_bottom_offset[i] specify the coordinates of the i-th rectangular region specified in the SEI message:
The offsets for the rectangular region are specified in units of luma samples. The i-th rectangular region contains the luma samples with horizontal picture coordinates from SubWidthC*regional_nesting_rect_left_offset[i] to pic_width_in_luma_samples−(SubWidthC*regional_nesting_rect_right_offset[i]+1), inclusive, and vertical picture coordinates from SubHeightC*regional_nesting_rect_top_offset[i] to pic_height_in_luma_samples−(SubHeightC*regional_nesting_rect_bottom_offset[i]+1), inclusive; and
   The value of SubWidthC*(regional_nesting_rect_left_offset[i]+regional_nesting_rect_right_offset[i]) shall be less than pic_width_in_luma_samples and the value of SubHeightC*(regional_nesting_rect_top_offset[i]+regional_nesting_rect_bottom_offset[i]) shall be less than pic_height_in_luma_samples.

The regional nesting SEI message provides a mechanism to associate SEI messages with regions of the picture. The associated SEI messages are conveyed within the regional nesting SEI message.

A regional nesting SEI message contains one or more SEI messages. When an SEI message is contained in a regional nesting SEI message, the contained SEI message is referred to as a region-nested SEI message. When an SEI message is not contained in a regional nesting SEI message, the SEI message is referred to as a non-region-nested SEI message.

For each region-nested SEI message in a regional nesting SEI message, one or more regions are specified in the regional nesting SEI message, and the semantics of the region-nested SEI message are to be interpreted as applying to each of these regions.

The list listOfRegionNestableMessage Types may comprise decoded_picture_hash SEI message.

Use of the decoded picture hash SEI message as a region-nested SEI message.

For purposes of interpretation of the decoded picture hash SEI message contained in a regional nesting SEI message, the decoded picture hash SEI message is derived from the samples of the indicated region only.

For the decoded picture hash SEI message without changes below, the following variables (underlined) are specified: (Option 2A):
Pic WidthInLumaSamples is set equal to pps_pic_width_in luma_samples−SubWidthC*regional_nesting_rect_right_offset[i]−SubWidthC*regional_nesting_rect_left_offset[i]:
PicHeightInLumaSamples is set equal to pps_pic_height_in_luma-samples−SubHeightC*regional nesting_rect_bottom_offset[i]−SubHeightC*regional_nesting_rect_top_offset[i]:
ChromaFormatIdc is set equal to sps_chroma_format_idc0;
BitDepth_{Y} and BitDepth_{C} are both set equal to BitDepth; and
ComponentSample[cIdx] is set to be the 2-dimension array of decoded sample values of the cIdx-th component of a decoded picture from which sample columns less than SubWidthC*regional_nesting_rect_left_offset[i] and samples rows less than SubHeightC*regional_nesting_rect_top_offset[i] have been cropped.

Alternatively, for the decoded picture hash SEI message with the changes below, the following variables (underlined) are specified: (Option 2B):
RegionX0 is set equal to SubWidthC*regional_nesting_rect_left_offset[i]:
RegionY0 is set equal to SubHeightC*regional_nesting_rect_top_offset[i];
Region Width is set equal to pic width in luma samples−SubWidthC*regional_nesting_rect_right_offset[i]−SubWidthC*regional_nesting_rect_left_offset[i];
RegionHeight is set equal to pic height in luma samples−SubHeightC*regional_nesting_rect_bottom_offset[i]−SubHeightC*regional_nesting_rect_top_offset[i]:
ChromaFormatIdc is set equal to sps_chroma_format_idc0;
BitDepth_{Y} and BitDepth_{C} are both set equal to BitDepth; and
ComponentSample[cIdx] is set to be the 2-dimension array of decoded sample values of the cIdx-th component of a decoded picture.

In an embodiment, it is indicated by an encoder that a region indicated by the decoded region hash SEI message or the regional nesting SEI message containing a decoded picture hash SEI message is a GDR clean area. In an embodiment, an indication that a region indicated by the decoded region hash SEI message or the regional nesting SEI message containing a decoded picture hash SEI message is a GDR clean area is decoded by a decoder or alike. In an embodiment, a decoder may use the decoded indication to display the GDR clean area and omit displaying of other areas (within a GDR picture and/or recovering pictures).

In an embodiment, a particular regional_nesting_id value (e.g. 256) may be specified to indicate that the region(s) indicated by the regional nesting SEI message are GDR clear area(s).

Also, a few changes (identified as underlined) in section “Decoded picture hash SEI message semantics” in H.274 are needed as follows.

### 8.8.2 Decoded Picture Hash SEI Message Semantics (H.274)

This message provides a hash for each colour component of the current decoded picture (or region).

Use of this SEI message requires the definition of the following variables (as underlined):
A region with its top-left luma sample relative to the top-left luma sample of the current picture. denoted by (RegionX0, RegionY0), and width and height, denoted by RegionWidth and RegionHeight. When RegionX0 or RegionY0 is not set. RegionX0 or RegionY0 is inferred to be equal to 0. When Region Width or RegionHeight is not set, RegionWidth or RegionHeight is inferred to be equal to PicWidthInLumaSamples or PicHeightInLumaSamples, respectively:
A chroma format indicator, denoted herein by ChromaFormatIdc.
A bit depth for the samples of the luma component, denoted herein by BitDepthY, and when ChromaFormatIdc is not equal to 0, a bit depth for the samples of the two associated chroma components, denoted herein by BitDepthC.
For each colour component cIdx, an array of samples ComponentSample[cIdx][x][y].

Prior to computing the hash, the decoded picture (or region) data are arranged into one or three strings of bytes called pictureData[cIdx] of lengths dataLen[cIdx] (underlined) as follows:

```
for( cIdx = 0; cIdx < dph_sei_single_component_flag ? 1 : 3; cIdx++ ) {
  if( cIdx = = 0 ) {
    compX0[cIdx] = RegionX0
    compY0[cIdx] = RegionY0
    compWidth[ cIdx ] = RegionWidth
    compHeight[ cIdx ] = RegionHeight
    compDepth[ cIdx ] = BitDepthY
  } else {
    compX0[cIdx] = RegionX0 / SubWidthC
    compY0[cIdx] = RegionY0 / SubWidthC
    compWidth[ cIdx ] = RegionWidth / SubWidthC
    compHeight[ cIdx ] = RegionHeight / SubWidthC
    compDepth[ cIdx ] = BitDepthC (29)
  }
  iLen = 0
  for( y = compY0[cIdx]; y < (compY0[cIdx] + compHeight[ cIdx ]); y++ ) /* raster scan order */
    for( x = compX0[cIdx]; x < (compX0[cIdx] + compWidth[ cIdx ]); x++) {
      pictureData[ cIdx ][ iLen++ ] = ComponentSample[ cIdx ][ x ][ y ] & 0xFF
      if( compDepth[ cIdx ] > 8 )
        pictureData[ cIdx ][ iLen++ ] = ComponentSample[ cIdx ][ x ][ y ] >> 8
    }
  dataLen[ cIdx ] = iLen
}
```

where ComponentSample[cIdx] is a 2-dimension array of the decoded sample values of a component of a decoded picture (or region).
dph_sei_picture_md5[cIdx][i] is the 16-byte MD5 hash of the cIdx-th colour component of the decoded picture (or region). The value of dph_sei_picture_md5[cIdx][i] shall be equal to the value of digestVal[cIdx] obtained as follows, using the MD5 functions defined in IETF RFC 1321:
   MD5Init(context)
   MD5Update(context, pictureData[cIdx], dataLen[cIdx]) (30)
   MD5Final(digestVal[cIdx], context)
dph_sei_picture_crc[cIdx] is the cyclic redundancy check (CRC) of the colour component cIdx of the decoded picture (or region). The value of dph_sei_picture_crc[cIdx] shall be equal to the value of crcVal[cIdx] obtained as follows:

```
crc = 0xFFFF
pictureData[cIdx][dataLen[cIdx]] = 0
pictureData[cIdx][dataLen[cIdx] + 1] = 0
for (bitIdx = 0; bitIdx < (dataLen[cIdx] + 2) * 8; bitIdx++) {
  dataByte = pictureData[cIdx][bitIdx >> 3]
  crcMsb = (crc >> 15) & 1
  bitVal = (dataByte >> ( 7 − bitIdx & 7))) & 1
  crc = (((crc << 1) + bitval) & 0xFFFF) \hat{ } (crcMsb * 0x1021)
}
crcVal[cIdx] = crc
```

dph_sei_picture_checksum[cIdx] is the checksum of the colour component cIdx of the decoded picture (or region). The value of dph_sei_picture_checksum[cIdx] shall be equal to the value of checksum Val[cIdx] obtained as follows:

```
  sum = 0
  for (y = compY0[cIdx]; y < ( compY0[cIdx] + compHeight[cIdx] ); y++)
    for (x = compX0[cIdx]; x < ( compX0[cIdx] + compWidth[cIdx] ); x++) {
      xorMask = (x & 0xFF) \hat{ } (y & 0xFF) \hat{ } (x >> 8) \hat{ } (y >> 8)
      sum = (sum + ((ComponentSample[cIdx][y * compWidth[cIdx]+x] & 0xFF) \hat{ } xorMask)) &
0xFFFFFFFF
      if (compDepth[cIdx] > 8)
        sum = (sum + ((ComponentSample[cIdx][y * compWidth[cIdx] + x] >> 8) \hat{ } xorMask))
& 0xFFFFFFFF
    }
checksumVal[cIdx] = sum
```

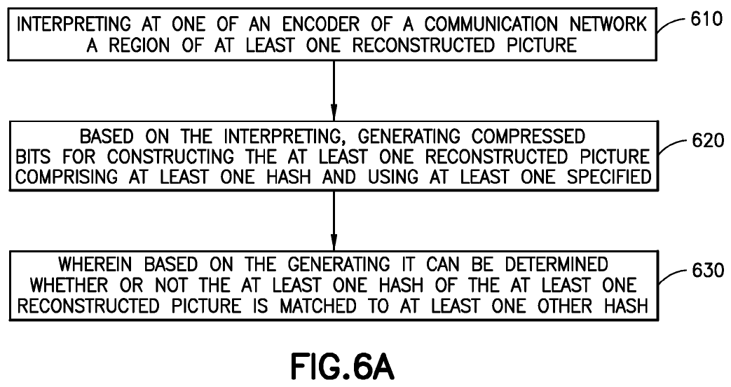

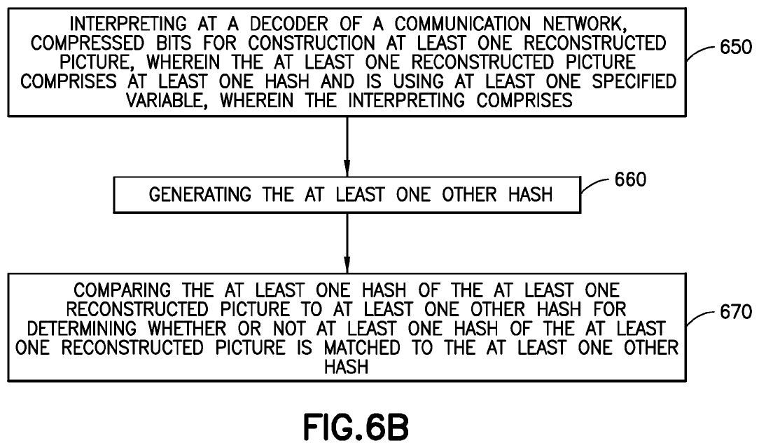

FIG. 6A illustrates operations which may be performed by a network device such as, but not limited to, a network node eNb/gNb 170 as in FIG. 5 or an eNB. As shown in step 610 of FIG. 6A there is interpreting at an encoder of a communication network a region of at least one reconstructed picture. As shown in step 620 of FIG. 6A there is based on the interpreting, generating compressed bits for constructing the at least one reconstructed picture comprising at least one hash and using at least one specified variable. Then as shown in step 630 of FIG. 6A there is shown wherein based on the generating it can be determined whether or not the at least one hash of the at least one reconstructed picture is matched to at least one other hash.

In accordance with the example embodiments as described in the paragraph above, there is sending the compressed bits for constructing the at least one reconstructed picture towards a decoder of the communication network.

In accordance with the example embodiments as described in the paragraphs above, wherein the determining is using a region-based hash supplemental enhancement information message encoded in the at least one reconstructed picture.

In accordance with the example embodiments as described in the paragraphs above, wherein the determining is using a region-nested hash supplemental enhancement information message encoded in the at least one reconstructed picture, wherein one or more regions are specified in the region-nested hash supplemental enhancement information message, and semantics of the region-nested hash supplemental enhancement information message are interpreted as applying to each of the specified one or more regions.

In accordance with the example embodiments as described in the paragraphs above, wherein the region-based hash supplemental enhancement information message comprises region-specific hash information.

In accordance with the example embodiments as described in the paragraphs above, wherein the region-specific hash information comprises a region-based supplemental enhancement information message.

In accordance with the example embodiments as described in the paragraphs above, wherein the region-based hash supplemental enhancement information message comprises definitions of at least one specified variable of the dimension array.

In accordance with the example embodiments as described in the paragraphs above, wherein the definitions comprise: a region with its top-left luma sample relative to the top-left luma sample of the current picture is denoted by (RegionX0, RegionY0), and width and height denoted by Region Width and RegionHeight, wherein when RegionX0 or RegionY0 is not set, RegionX0 or RegionY0 is inferred to be equal to 0, or wherein when RegionWidth or RegionHeight is not set, RegionWidth or RegionHeight is inferred to be equal to PicWidthInLumaSamples or PicHeightInLumaSamples, respectively.

In accordance with the example embodiments as described in the paragraphs above, wherein the region-based hash supplemental enhancement information message comprises a decoded region hash.

In accordance with the example embodiments as described in the paragraphs above, wherein the decoded region hashcomprises indications of region settings for the at least one reconstructed picture.

In accordance with the example embodiments as described in the paragraphs above, wherein the region settings comprise indications of a dimension array for determining if the at least one hash of the at least one reconstructed picture is matched or not.

In accordance with the example embodiments as described in the paragraphs above, wherein the dimension array comprises values identifying the at least one specified variable for the interpreting.

In accordance with the example embodiments as described in the paragraphs above, wherein the at least one specified variable comprises: RegionX0 is set equal to region_x0, RegionY0 is set equal to region_y0, RegionWidth is set equal to region_width, and RegionHeight is set equal to region_height

In accordance with the example embodiments as described in the paragraphs above, wherein: region_x0 is a horizontal offset from a top-left corner of the at least one reconstructed picture, region_y0 is a vertical offset from a top-left corner of the at least one reconstructed picture, region_width is a width of a specific region of the at least one reconstructed picture, and region_height is a height of a specific region of the at least one reconstructed picture.

In accordance with the example embodiments as described in the paragraphs above, wherein at least one hash of the at least one reconstructed picture provides a hash for each colour component of at least one region of the at least one reconstructed picture.

A non-transitory computer-readable medium (Memory(ies) 155 as in FIG. 5) storing program code (Computer Program Code 153 and/or PB Module 150-2 as in FIG. 5), the program code executed by at least one processor (Processors 152 and/or PB Module 150-1 as in FIG. 5) to perform the operations as at least described in the paragraphs above.

In accordance with an example embodiment of the invention as described above there is an apparatus comprising: means for interpreting (Remote radio head 195, Memory(ies) 155, Computer Program Code 153 and/or PB module 150-2, and Processor(s) 152 and/or PB Module 150-1 as in FIG. 5) at an encoder (eNB/gNB 170 as in FIG. 5) of a communication network (Network 100 as in FIG. 5) a region of at least one reconstructed picture: based on the interpreting, means for generating (Remote radio head 195, Memory(ies) 155, Computer Program Code 153 and/or PB module 150-2, and Processor(s) 152 and/or PB Module 150-1 as in FIG. 5) compressed bits for constructing the at least one reconstructed picture comprising at least one hash and using at least one specified variable: and means, based on the generating (Remote radio head 195, Memory(ies) 155, Computer Program Code 153 and/or PB module 150-2, and Processor(s) 152 and/or PB Module 150-1 as in FIG. 5) it can be determined whether or not the at least one hash of the at least one reconstructed picture is matched to at least one other hash.

In the example aspect of the invention according to the paragraph above, wherein at least the means for interpreting, and generating comprises a non-transitory computer readable medium [Memory (ies) 155 as in FIG. 5] encoded with a computer program [Computer Program Code 153 and/or PB Module 150-2 as in FIG. 5] executable by at least one processor [Processor(s) 152 and/or PB Module 150-1 as in FIG. 5].

FIG. 6B illustrates operations which may be performed by a device such as, but not limited to, a device (e.g., the UE 110 as in FIG. 5). As shown in step 650 of FIG. 6B there is interpreting at a decoder of a communication network compressed bits for constructing at least one reconstructed picture, wherein the at least one reconstructed picture comprises at least one hash and is using at least one specified variable. As shown in step 660 of FIG. 6B wherein the interpreting comprises generating at least one other hash. Then as shown in step 670 of FIG. 6B there is comparing the at least one hash of the at least one reconstructed picture to the at least one other hash for determining whether or not at least one hash of the at least one reconstructed picture is matched to the at least one other hash.

In accordance with the example embodiments as described in the paragraph above, there is receiving from an encoder of the communication network compressed bits and decoding the compressed bits for constructing the at least one reconstructed picture comprising at least one hash and using at least one specified variable.

In accordance with the example embodiments as described in the paragraphs above, wherein the determining is using a region-based hash supplemental enhancement information message encoded in the at least one reconstructed picture.

In accordance with the example embodiments as described in the paragraphs above, wherein the determining is using a region-nested hash supplemental enhancement information message encoded in the at least one reconstructed picture, wherein one or more regions are specified in the region-nested hash supplemental enhancement information message, and semantics of the region-nested hash supplemental enhancement information message are interpreted as applying to each of the specified one or more regions.

In accordance with the example embodiments as described in the paragraphs above, wherein the region-based hash supplemental enhancement information message comprises region-specific hash information.

In accordance with the example embodiments as described in the paragraphs above, wherein the region-specific hash information comprises a region-based supplemental enhancement information message.

In accordance with the example embodiments as described in the paragraphs above, wherein the region-based hash supplemental enhancement information message comprises definitions of at least one specified variable of the dimension array.

In accordance with the example embodiments as described in the paragraphs above, wherein the definitions comprise: a region with its top-left luma sample relative to the top-left luma sample of the current picture is denoted by (RegionX0, RegionY0), and width and height denoted by RegionWidth and RegionHeight, wherein when RegionX0 or RegionY0 is not set, RegionX0 or RegionY0 is inferred to be equal to 0, or wherein when RegionWidth or RegionHeight is not set, RegionWidth or RegionHeight is inferred to be equal to PicWidthInLumaSamples or PicHeightInLumaSamples, respectively.

In accordance with the example embodiments as described in the paragraphs above, wherein the region-based hash supplemental enhancement information message comprises a decoded region hash.

In accordance with the example embodiments as described in the paragraphs above, wherein the decoded region hash comprises indications of region settings for the at least one reconstructed picture.

In accordance with the example embodiments as described in the paragraphs above, wherein the region settings comprise indications of a dimension array for determining if the at least one hash of the at least one reconstructed picture is matched or not.

In accordance with the example embodiments as described in the paragraphs above, wherein the dimension array comprises values identifying the at least one specified variable for the interpreting.

In accordance with the example embodiments as described in the paragraphs above, wherein the at least one specified variable comprises: RegionX0 is set equal to region_x0, RegionY0 is set equal to region_y0, RegionWidth is set equal to region_width, and RegionHeight is set equal to region_height

In accordance with the example embodiments as described in the paragraphs above, wherein: region_x0 is a horizontal offset from a top-left corner of the at least one reconstructed picture, region_y0 is a vertical offset from a top-left corner of the at least one reconstructed picture, region_width is a width of a specific region of the at least one reconstructed picture, and region_height is a height of a specific region of the at least one reconstructed picture.

In accordance with the example embodiments as described in the paragraphs above, wherein at least one hash of the at least one reconstructed picture provides a hash for each colour component of at least one region of the at least one reconstructed picture.

A non-transitory computer-readable medium (Memory(ies) 125 as in FIG. 5) storing program code (Computer Program Code 123 and/or PB Module 140-2 as in FIG. 5), the program code executed by at least one processor (Processors 120 and/or PB Module 140-1 as in FIG. 5) to perform the operations as at least described in the paragraphs above.

In accordance with an example embodiment of the invention as described above there is

an apparatus comprising: means for interpreting (one or more transceivers 130, Memory(ies) 125, Computer Program Code 123 and/or PB module 140-2, and Processor(s) 120 and/or PB Module 140-1 as in FIG. 5) compressed bits for constructing at least one reconstructed picture, wherein the at least one reconstructed picture comprises at least one hash and is using at least one specified variable, wherein the interpreting comprises generating (one or more transceivers 130, Memory(ies) 125, Computer Program Code 123 and/or PB module 140-2, and Processor(s) 120 and/or PB Module 140-1 as in FIG. 5) at least one other hash: and means for comparing ( )the at least one hash of the at least one reconstructed picture to the at least one other hash for determining (one or more transceivers 130, Memory(ies) 125, Computer Program Code 123 and/or PB module 140-2, and Processor(s) 120 and/or PB Module 140-1 as in FIG. 5) whether or not at least one hash of the at least one reconstructed picture is matched to the at least one other hash.

In the example aspect of the invention according to the paragraph above, wherein at least the means for interpreting, generating, and determining comprises a non-transitory computer readable medium [Memory(ies) 125 as in FIG. 5] encoded with a computer program [Computer Program Code 123 and/or Transform Module 140-2 as in FIG. 5] executable by at least one processor [Processor(s) 120 and/or Transform Module 140-1 as in FIG. 5].

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry):
(b) combinations of hardware circuits and software, such as (as applicable):
   (i) a combination of analog and/or digital hardware circuit(s) with software/firmware: and
   (ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein): and
(c) hardware circuit(s) and or processor(s), such as a microprocessor(s) or a portion of a microprocessor(s), that requires software (e.g., firmware) for operation, but the software may not be present when it is not needed for operation.”

In accordance with example embodiments of the invention, there is adequate circuitry for performing at least novel operations as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of circuitry' applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1-60. (canceled)

61. A method, comprising:
interpreting at an encoder a region of at least one reconstructed picture; and
based on the interpreting, generating, using at least one specified variable, compressed bits for constructing the at least one reconstructed picture comprising at least one hash,
determining, based on the generating, whether or not the at least one hash of the at least one reconstructed picture is matched to at least one other hash

62. An apparatus comprising:
at least one processor; and
at least one non-transitory memory including computer program code, where the at least one non-transitory memory and the computer program code are configured, with the at least one processor, to cause the apparatus to at least:
interpret at an encoder a region of at least one reconstructed picture; and
based on the interpreting, generate compressed bits for constructing the at least one reconstructed picture comprising at least one hash and using at least one specified variable,
determine, based on the generate compressed bits, whether or not the at least one hash of the at least one reconstructed picture is matched to at least one other hash.

63. The apparatus of claim 62, wherein the at least one non-transitory memory including the computer program code is configured with the at least one processor to cause the apparatus to:
send the compressed bits for constructing the at least one reconstructed picture to a decoder

64. The apparatus of claim 62, wherein to determine whether or not the at least one hash of the at least one reconstructed picture is matched to the at least one other hash, the at least one non-transitory memory including the computer program code is configured with the at least one processor to cause the apparatus to use a region-based hash supplemental enhancement information message encoded in the at least one reconstructed picture.

65. The apparatus of claim 62, wherein to determine whether or not the at least one hash of the at least one reconstructed picture is matched to the at least one other hash, the at least one non-transitory memory including the computer program code is configured with the at least one processor to cause the apparatus using a region-nested hash supplemental enhancement information message encoded in the at least one reconstructed picture, and wherein one or more regions are specified in the region-nested hash supplemental enhancement information message, and semantics of the region-nested hash supplemental enhancement information message are interpreted while being used for each of the specified one or more regions.

66. The apparatus of claim 64, wherein the region-based hash supplemental enhancement information message comprises at least one of the following
a region-specific hash information;
definitions of at least one specified variable of the dimension array; or
a decoded region hash.

67. The apparatus of claim 66, wherein the region-specific hash information comprises a region-based supplemental enhancement information message.

68. The apparatus of claim 66, wherein when the region-based hash supplemental enhancement information message comprises definitions of the at least one specified variable of the dimension array, the definitions comprise:
a region with its top-left luma sample relative to the top-left luma sample of the current picture is denoted by (RegionX0, RegionY0), and width and height denoted by RegionWidth and RegionHeight, wherein when RegionX0 or RegionY0 is not set, RegionX0 or RegionY0 is inferred to be equal to 0, or
wherein when RegionWidth or RegionHeight is not set, RegionWidth or RegionHeight is inferred to be equal to PicWidthInLumaSamples or PicHeightInLumaSamples, respectively.

69. The apparatus of claim 66, wherein when the region-based hash supplemental enhancement information message comprises the decoded region hash, the decoded region hash comprises indications of region settings for the at least one reconstructed picture, wherein the region settings comprise indications of a dimension array for determining whether the at least one hash of the at least one reconstructed picture is matched or not to the at least one other hash, wherein the dimension array comprises values identifying the at least one specified variable for the interpreting, wherein the at least one specified variable comprises:
RegionX0 is set equal to region_x0; wherein region_x0 is a horizontal offset from a top-left corner of the at least one reconstructed picture;
RegionY0 is set equal to region_y0; wherein region_y0 is a vertical offset from a top-left corner of the at least one reconstructed picture;
RegionWidth is set equal to region_width;
region_width is a width of a specific region of the at least one reconstructed picture; and
RegionHeight is set equal to region_height; wherein region_height is a height of a specific region of the at least one reconstructed picture.

70. The apparatus of claim 62, wherein at least one hash of the at least one reconstructed picture provides a hash for each colour component of at least one region of the at least one reconstructed picture.

71. A method, comprising:
interpreting at a decoder of a communication network compressed bits for constructing at least one reconstructed picture from an encoder of the communication network, wherein at least one region of the at least one reconstructed picture comprises at least one hash and is using at least one specified variable, wherein the interpreting comprises generating at least one other hash; and
comparing the at least one hash of the at least one reconstructed picture to the at least one other hash;
determining, based on the comparing, whether or not the at least one hash of the at least one reconstructed picture is matched to the at least one other hash.

72. An apparatus comprising:
at least one processor; and
at least one non-transitory memory including computer program code, where the at least one non-transitory memory and the computer program code are configured, with the at least one processor, to cause the apparatus to at least:
interpret, at a decoder, compressed bits for constructing at least one reconstructed picture, wherein the at least one reconstructed picture comprises at least one hash and is using at least one specified variable from an encoder of the communication network, wherein the interpreting comprises
generate at least one other hash; and
compare the at least one hash of the at least one reconstructed picture to the at least one other hash; determine, based on the comparison, whether or not the at least one hash of the at least one reconstructed picture is matched to the at least one other hash.

73. The apparatus of claim 72, wherein the at least one non-transitory memory including the computer program code is configured with the at least one processor to cause the apparatus to:
receive from an encoder of the communication network the compressed bits for constructing the at least one reconstructed picture comprising the at least one hash and using the at least one specified variable;

74. The apparatus of claim 72, wherein to determine, whether or not the at least one hash of the at least one reconstructed picture is matched to the at least one other hash, the at least one non-transitory memory including the computer program code is configured with the at least one processor to cause the apparatus to: use a region-based hash supplemental enhancement information message encoded in the at least one reconstructed picture.

75. The apparatus of claim 72, wherein to determine whether or not the at least one hash of the at least one reconstructed picture is matched to the at least one other hash, the at least one non-transitory memory including the computer program code is configured with the at least one processor to cause the apparatus to use a region-nested hash supplemental enhancement information message encoded in the at least one reconstructed picture, wherein one or more regions are specified in the region-nested hash supplemental enhancement information message, and semantics of the region-nested hash supplemental enhancement information message are interpreted while being used for each of the specified one or more regions.

76. The apparatus of claim 74, wherein the region-based hash supplemental enhancement information message comprises at least one of
region-specific hash information;
definitions of at least one specified variable of the dimension array; or
a decoded region hash.

77. The apparatus of claim 76, wherein the region-specific hash information comprises a region-based supplemental enhancement information message.

78. The apparatus of claim 76, wherein when the region-based hash supplemental enhancement information message comprises definitions of the at least one specified variable of the dimension array, the definitions comprise:
a region with its top-left luma sample relative to the top-left luma sample of the current picture is denoted by (RegionX0, RegionY0), and width and height denoted by RegionWidth and RegionHeight, wherein when RegionX0 or RegionY0 is not set, RegionX0 or RegionY0 is inferred to be equal to 0, or
wherein when RegionWidth or RegionHeight is not set, RegionWidth or RegionHeight is inferred to be equal to PicWidthInLumaSamples or PicHeightInLumaSamples, respectively.

79. The apparatus of claim 76, wherein when the region-based hash supplemental enhancement information message comprises the decoded region hash, the decoded region hash comprises indications of region settings for the at least one reconstructed picture, wherein the region settings comprise indications of a dimension array for determining if the at least one hash of the at least one reconstructed picture is matched or not to the at least one other hash, wherein the dimension array comprises values identifying the at least one specified variable for the interpreting, wherein the at least one specified variable comprises:
RegionX0 is set equal to region_x0, wherein region_x0 is a horizontal offset from a top-left corner of the at least one reconstructed picture,
RegionY0 is set equal to region_y0, wherein region_y0 is a vertical offset from a top-left corner of the at least one reconstructed picture,
RegionWidth is set equal to region_width, wherein region_width is a width of a specific region of the at least one reconstructed picture, and
RegionHeight is set equal to region_height wherein region_height is a height of a specific region of the at least one reconstructed picture.

80. The apparatus of claim 72, wherein at least one hash of the at least one reconstructed picture comprises a hash for each colour component of at least one region of the at least one reconstructed picture.
